(19) United States
(12) Patent Application Publication
(10) Pub. No.: US 2023/0034481 A1
(43) Pub. Date: Feb. 2, 2023

(54) IOT BASED FIRE AND DISASTER MANAGEMENT SYSTEMS AND METHODS

(71) Applicant: PFPR Limited, Stamford (GB)

(72) Inventors: David Benton, Stamford (GB); Jacob Benton, Stamford (GB); Simon Benton, Stamford (GB); Lizzie Benton, Stamford (GB); Dean Lynn, Stamford (GB)

(73) Assignee: PFPR Limited, Stamford (GB)

(21) Appl. No.: 17/668,391

(22) Filed: Feb. 10, 2022

Related U.S. Application Data
(60) Provisional application No. 63/148,123, filed on Feb. 10, 2021.

(51) Int. Cl. G08B 29/04; G08B 31/00; G06K 9/00; G16Y 20/10; G16Y 10/80

(52) U.S. Cl. CPC G08B 29/043; G08B 31/00; G06K 9/00536; G16Y 20/10; G16Y 10/80

(57) ABSTRACT

Some embodiments are directed to a system that includes multiple fire sensors and equipment, and mobile devices of the users of the system. These fire sensors and equipment are configured in a network so as to allow communication with a processor. A processor in the system interrogates the status of the fire sensors and fire safety elements on a continuous basis. Upon a change in system status, the processor interprets the change and classifies according to operation state or probability of a fire or other imminent threat. The data, processing and storage provide the means by which occupants and potential occupants can better navigate a building during the occurrence of a fire. The system enables communication between users of the system through their mobile devices used and communication between devices that may be present in the

### BACKGROUND

Some embodiments provide methods and apparatus for IOT based fire and disaster management systems and management.

Related art fire detection and prevention systems are subject to multiple disadvantages. For example, the current systems fail to enable communication among the multiple sensors and equipment and fail to utilize predictive analytics and thus fail to provide enhanced outcomes.

### SUMMARY

Thus, some embodiments are directed to facilitating communication between multiple fire system elements and to use data analytics to predict fire related events and provide enhanced outcomes. Some embodiments are directed to a system that includes multiple fire detection and other sensors, fire safety elements (e.g., door closure devices) and mobile devices such as cellular phones. These fire sensors and safety elements are configured in a network (e.g., a mesh, Bluetooth or other network technology) so as to allow communication with a processor. A processor in the system interrogates the status of the fire sensors and fire safety elements on a continuous basis. The processor also has access to cellular data from mobile devices so as to allow it an additional means for assessing if occupants may be present in the building. Furthermore, the system writes the data on an on-going basis into a storage media to enable documentation and analysis of patterns in sensor data as well as safety element operational status and positional data of occupants from cell phone data.

The data, processing and storage provide the means by which occupants and potential occupants can better navigate a building during the occurrence of a fire. Such system is informed by sensor and fire safety elements to allow more rapid egress from the building. Fire crews who are equipped with the data from the system can be provided with building maps which are augmented with sensor and fire safety element status as well as occupancy status obtained from both sensors and cell phone positional status. Furthermore, the system affords the ability to inform building managers and owners to preform maintenance using both data and processing of data on operational status of sensors and fire safety elements.

Some embodiments relate to a system for detecting or addressing a fire or fire related event in a facility, the system being configured for use with multiple fire related sensors and equipment, the system also being configured for use with mobile devices of system users. The system comprises of a controller configured to continuously interrogate status of the fire related sensors and equipment, identify a change in the status, and classify the status change according to operation state and probability of the fire related event. The controller is also configured to access data of the mobile devices to determine whether the mobile devices are disposed within the facility. Some embodiments relate to a network that is configured to enable communications between the controller, the fire related sensors and equipment, and the mobile devices; and a storage medium that stores data received from the controller and from which the controller is configured to analyze patterns in the fire related sensors and equipment that enable prediction of the fire related event and measures for enhancing outcomes.

### BRIEF DESCRIPTIONS OF DRAWINGS

FIG. 1a is a diagrammatic representation of a fire safety system in accordance with the current disclosure. It shows a fire safety system 10 in accordance with the current disclosure. The fire safety system 10 may be used in any dwelling and is specifically suited for use in a commercial or multiple occupancy buildings, such as for example hospitals, schools, factories, offices, flats or tower blocks;

FIG. 1b is a schematic representation of an identifier used in the fire safety system of FIG. 1a;

FIG. 2 is a schematic representation of an embodiment of a fire door suitable for use in the fire safety system of FIG. 1a;

FIGS. 3a-3f are schematic representations of embodiments of a fire window suitable for use 20 in the fire safety system of FIG. 1a;

FIG. 4 is a schematic representation of another embodiment of a fire barrier suitable for use in the fire safety system of FIG. 1a

FIG. 5 is a diagrammatic representation of an exemplary method of operating the fire safety system of FIG. 1a;

FIG. 6 is a diagrammatic representation of another exemplary method of operating the fire safety system of FIG. 1a.

FIG. 7 is a schematic representation of an exemplary method of connecting and accessing equipment data via the network.

FIG. 8 is a flow chart of another exemplary method of tracking inventory and equipment status.

FIG. 9 is a schematic representation of an exemplary method of network topology.

FIG. 10 is a diagrammatic representation of an embodiment of a door open/close sensor.

FIG. 11 is a schematic representation of an exemplary method of connecting equipment via the network and IOT.

FIG. 12 is a schematic representation of an exemplary method of connecting tools or control panel and a technician.

### DETAILED DESCRIPTION OF DRAWINGS

These and other features and advantages are described in, or are apparent from, the following detailed description of various exemplary embodiments.

It will be understood that when an element is referred to as being “on”, “connected”, or “coupled” to another element, it can be directly on, connected, or coupled to the other element or intervening elements that may be present. In contrast, when an element is referred to as being “directly on”, “directly connected”, or “directly coupled” to another element, there are no intervening elements present. As used herein the term “and/or” includes any and all combinations of one or more of the associated listing items. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present.

It will be understood that, although the terms “first”, “second”, etc. may be used herein to describe various elements, components, regions, layers, and/or sections, these elements, components, regions, layers and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of exemplary embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized embodiments (and intermediate structures) of exemplary embodiments. As such, variations from the shapes of the illustrations as a result, for exemplary, of manufacturing techniques and/or tolerances, are to be expected. Thus, exemplary embodiments should not be construed as limited to the particular shapes of regions illustrated herein but are to include deviations in shapes that result, for exemplary, from manufacturing. For exemplary, an implanted region illustrated as a rectangle will, typically, have rounded or curved features and/or a gradient of implant concentration at its edges rather than a binary change from implanted to non-implanted region. Likewise, a buried region formed by the implantation may result in some implantation in the region between the buried region and the surface through which the implantation takes place. Thus, the regions illustrated in the figures are schematic in nature and their shapes are not intended to illustrate the actual shape of a region of a device and are not intended to limit to scope of exemplary embodiments.

Unless otherwise defined, all terms (including technical and scientific terms) used herein have the same meaning as commonly understood by one of ordinary skill in the art to which exemplary embodiments belong. It will be further understood that all terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of”, when preceding a list of elements, modify the entire list of elements and do not modify the individual elements of the list.

When the terms “about” or “substantially” are used in this specification in connection with numerical values, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1a %. Moreover, when the words “generally” and “substantially” are used in connection with geometric shapes, it is intended that the precision of the geometric shape is not required but that latitude for the shape is within the scope of the disclosure. Although the tubular elements of the embodiments may be cylindrical, other tubular cross-sectional forms are contemplated, such as square, rectangular, oval, triangular, and others.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For exemplary, when a device structure (e.g., a memory cell structure or transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

With this IoT inventive concept, building owners are now able to substantially reduce the operating costs through interrogation of the Fire protection systems' ongoing “health” to control false alarms and unscheduled emergency repairs. They also are better able to reduce service costs by ensuring the right part is brought on-site the first time when a repair is needed. The IoT is being used to develop unique applications using power over ethernet to reduce cable costs and provide design flexibility.

Making use of a MeSH network and IoT devices to enable operational status and predictive analytics surrounding a building fire. This system (in part or in whole) is designed for use in any dwelling—and is specifically suited for use in a commercial or multiple occupancy building; such as hospitals, schools, factories, offices, residential rental properties or multi-level office buildings. Such buildings or locations may be divided into logical ‘zones’ to facilitate information storage and exchange.

System integrates a variety of fire barriers (which can comprise a wrap, a collar, a mold, and/or a fire pillow), fire doors, windows, fire extinguishers, and other architectural building elements that may either help to assist in early and continued assessment of a fire as well as offer predictive insights that can reduce the risk of a fire or insights on how to reduce loss of life and property should a fire occur.

The system can involve either a retrofit of existent windows, doors, barriers, extinguishers to equip these elements with a combination of fire safety elements: electronic, labels, and/or mechanical elements: sensors/receivers/transmitters/local alarms and actuators/scannable tags (e.g., QR codes, RFID, and other coding schemas) as well as means of monitoring occupancy status of given rooms, hallways, roof or other areas of a building.

Parts of or the entirety of fire safety elements can be deployed in a variety of locations (within a given structure, such as a door/window/barrier, adjacent to the structure, or in an area that the safety element's operational or functional status can be observed by a surveillance device.

The invention also focuses on insuring that key structures are covered with sensors and monitoring—such as the entrance/exit to a building—kitchen doors, windows and screens. Also, service rooms such as electrical, heat/cooling, and garages.

The system can make use of an app and/or a website can be developed with a ‘role-based’ enrollment and use to allow use by the following roles:
Tenants
Guests
Inspectors
Property Owners
Fire Brigade
Maintenance workers/company
Insurance providers

The app can show approval status, regulatory status and compliance of system, updates that may be needed in physical elements, firmware, or other issues that have been documented by the community (through the QR code system or otherwise). The subsections/topics discussed are below.
Controlling the Spread of Fire
IOT
Industrial Applicability
Connected Equipment
Predictive Diagnostics
Machine Learning
Contamination tracking for laboratories, hospitals, and other settings

### I. Controlling the Spread of Fire

### A. Overview

A computerized method for evaluating and reporting a fault in a building management system includes receiving at a processing circuit multiple fault indications for different building equipment of the building management system. The method further includes displaying a single fault related to the multiple fault indications rather than reporting the multiple fault indications.

In a fire alarm system, a plurality of terminal equipment are connected to a control panel. The terminal equipment includes a first terminal equipment provided with a first mode in which the first terminal equipment is controlled by the control panel and a second mode in which the first terminal equipment controls a second terminal equipment which is other than the first terminal equipment. The utility model discloses a hide hinge and automatic start/stop device's fire window including window frame casement automatic start/stop device one side of casement articulates in the window frame respectively be equipped with the spout in the last frame of window frame the underframe automatic start/stop device includes: the sliding block is sleeved in the sliding groove and is in sliding fit with the sliding groove the motor drives the sliding block to slide along the sliding groove a connecting rod is hinged between the top surface of the sliding block and the window sash the temperature detection device is installed on one side of the inner bottom of the window frame and the temperature detection device is in signal connection with the motor. The utility model discloses novel structure hides hinge and automatic start/stop device in the window frame realizes automatic start/stop avoids automatic start/stop device to expose outside and is pleasing to the eye practical plays the guard action.

A method and system for configured one or more fire alarm system devices in a fire alarm system are disclosed. The fire alarm system includes the fire alarm system devices a fire alarm panel and a wireless handheld device. The fire alarm system devices communicate with the fire alarm panel via a first communications interface (such as a wired communications interface) and the wireless handheld device communicates with the fire alarm panel via a second communications interface (such as a wireless communications interface). In operation the fire alarm control panel receives an indication from one of the fire alarm system devices of a user input. In response the fire alarm panel sends a communication (such as a form) to the wireless handheld device. In response to the communication the wireless handheld device sends a response to the fire alarm control panel (such as including information in the form). The fire alarm panel may then update its memory with the information sent from the wireless handheld device in order to control the operation of the fire alarm system device.

A computerized method for evaluating and reporting a cause of a performance change in a building management system is shown and described. The method includes receiving an indication of a fault for building equipment of the building management system and determining a root cause for the fault by traversing a causal relationship model including the building equipment and other devices of the building management system.

Reference will now be made in detail to embodiments, exemplary of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain exemplary embodiments of the present description.

In many instances, buildings are compartmentalized to delay the spread of fire from one area to another. In such instances, particularly instances where buildings are large, these compartments are linked by fire doors, which may allow the flow of traffic around the building. Such fire doors may serve two purposes. When closed, they may act as a barrier to stop the spread of fire. When opened, they may provide a means of escape. A well-designed fire door will delay the spread of fire and smoke without causing too much hindrance to the movement of people or goods. Every fire door is therefore required to act as a barrier to the passage of smoke and/or fire to varying degrees, dependent upon its location in a building as well as the fire hazards associated with that building.

In order to successfully delay the passage of fire and remain a strong barrier, these fire doors may contain particular features that serve to aid them in containing the fires. The door itself is usually constructed of a solid timber frame and may be covered in fire-resistant glass. Such glad should be constructed such that it may be able to withstand exposure to the heat condition in a fire test for at least 60 minutes before it reaches a temperature high enough to soften it. Further, an intumescent seal surrounds the door, the seal designed to expand to seal the gaps between the door and the frame when temperatures reach beyond 200° C. Such an intumescent seal may prevent the spread of fire from between the door and door frame. These gaps between the door and door frame must, in many instances, be of a size less than 4mm when the door is closed. The gap under the door may be slightly larger, up to 8 mm. This regulation ensures that door gaps are not large enough for a substantial amount of smoke or flames to pass through.

Before installation, all fire doors must be properly and adequately tested to ensure they are built to successfully delay the spread of fire. The first step in this certification process is the manufacturing of fire doors, wherein a manufacturer will construct a fire door set that, in their opinion, will resist fire for a specified amount of time. The door set will then be tested by an approved fire testing center. Such an inspection may include testing and checking of the door's hinges, bolts, gap between door and door frame, fasteners, locks, and any additional features. If the door set passes this inspection, any door sets constructed to that specification may be considered for certification. Once the certification is approved, each similarly constructed door set will be identified by a label identifying the manufacturer, the date of manufacture, and the designed fire rating of the door type. This identification label may typically be affixed to the top edge of the door. In some instances, a color-coded plug may be inserted into the door, in addition to or instead of the label. In hospitals, fire doors may display a disc at the top of each face of the door showing the designated fire performance.

After initial certification and installation of fire doors, it is important that fire doors are continuously monitored and inspected for damage. Fire doors must be inspected annually such that any damage is noted and replacements or repairs may be made in a timely manner, before a fire can get through the damaged fire door. Fire door inspections may consist of a number of steps to ensure the door is up to standard, examples of fire door requirements are as follows. The visual inspection criteria for a fire door may include ensuring that no open holes or breaks exist in surfaces of either the door or frame, glazing, vision light frames, and glazing beads are intact and securely fastened in place, if so equipped, and no parts are missing or broken. Furthermore, the door, frame, hinges, hardware, and noncombustible threshold must be secured, aligned, and in working order with no visible signs of damage. Door clearances must not extend three-quarters inch under the bottom of the door, and one-eighth inch at the top, hinge, and latch edges of the door. The self-closing device must be operational, such that the active door completely closes when operated from the fully open position. If a coordinator is installed, the inactive leaf must close before the active leaf. Latching hardware should operate and secure the door when in a closed position, and auxiliary hardware items that may interfere or prohibit operation are not installed on the door or frame. Lastly, no field modifications to the door that void the label should be performed, and gaskets and seals must be inspected to verify their presence and integrity where required. The aforementioned fire door requirements are examples of requirements, inspections may consist of additional or different steps and requirements, dependent on the circumstances surrounding the door, and location of the door.

As mentioned above, fire doors must be inspected annually to identify any damage to the door or surrounding areas. However, in many instances, substantial damage may be done to fire doors in the time between inspections. In fact, some studies have found that around 15% of active fire doors are damaged, and thus ineffective. Damage to fire doors can have a number of causes, one of the most common being tenants or others inflicting damage upon the doors. For example, kicking the doors, slamming them shut, or breaking the hinges can all be extremely damaging to the fire door and render it useless, incapable of preventing the spread of fire. Damage like this can go unnoticed between inspections, or even during poor quality inspections.

Embodiments of the present disclosure include a computer system for a BMS (e.g., a BMS controller) that has been configured to help make differences in building subsystems transparent at the human-machine interface, application, or client interface level. The computer system is configured to provide access to different building devices and building subsystems using common or unified building objects (e.g., software objects stored in memory) to provide the transparency. In an exemplary embodiment, a software defined building object (e.g., “virtual building object,” “virtual device”) groups multiple properties from disparate building systems and devices into a single software object that is stored in memory and provided by a computer system for interaction with other systems or applications (e.g., front-end applications, control applications, remote applications, client applications, local processes, etc.). Multiple software defined building objects may be described as forming an abstraction layer of software framework or architecture. Benefits such as allowing developers to write applications that will work regardless of a particular building subsystem makeup (e.g., particular naming conventions, particular protocols, etc.) may be provided by such software defined building objects.

Each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.). In some buildings, multiple HVAC systems or subsystems may exist in parallel and may not be a part of the same HVAC system 20.

### B. BMS Inputs, Controller, and Subsystem

HVAC system may also receive data a temperature setpoint, a damper position, temperature sensor readings, etc. HVAC system may then provide such inputs up to HVAC system and on to middleware and BMS controller. Similarly, other subsystems may receive inputs from other building devices or objects and provide them to middleware and BMS controller (e.g., via middleware). For example, a window control system may receive shade control information from one or more shade controls, may receive ambient light level information from one or more light sensors, or may receive other BMS inputs (e.g., sensor information, setpoint information, current state information, etc.) from downstream devices. Window control system may include window controllers. Lighting system may receive lighting related information from a plurality of downstream light controls, for example, from room lighting. Door access system may receive lock control, motion, state, or other door related information from a plurality of downstream door controls. Door access system is shown to include door access pad, which may grant or deny access to a building space (e.g., floor, conference room, office, etc.) based on whether valid user credentials are scanned or entered (e.g., via a keypad, via a badge-scanning pad, etc.).

BMS subsystems are shown as connected to BMS controller via middleware and are configured to provide BMS controller with BMS inputs from the various BMS subsystems and their varying downstream devices. BMS controller is configured to make differences in building subsystems transparent at the human-machine interface or client interface level (e.g., for connected or hosted user interface (UI) clients, remote applications, etc.). BMS controller is configured to describe or model different building devices and building subsystems using common or unified building objects (e.g., software objects stored in memory) to help provide the transparency. Benefits such as allowing developers to write applications that will work regardless of the building subsystem makeup may be provided by such software building objects.

The local control circuitry of the building devices may also be configured to receive and respond to control signals, commands, setpoints, or other data from their supervisory controllers. The local control circuitry may include circuitry that affects an actuator in response to control signals received from a field controller that is a part of HVAC system. Window controller may include circuitry that affects windows or blinds in response to control signals received from a field controller that is part of window control system (WCS). Lighting systems may include circuitry that affects the lighting in response to control signals received from a field controller that is part of lighting system. Access pad may include circuitry that affects door access (e.g., locking or unlocking the door) in response to control signals received from a field controller that is part of door access system.

In conventional buildings, the BMS subsystems are often managed separately. Even in BMSs where a unified graphical user interface is provided, a user must typically click through a hierarchy to view data points for a lower level device or to make changes (e.g., setpoint adjustments, etc.). Such separate management can be particularly true if the subsystems are from different manufacturers or communicate according to different protocols. Conventional control software in such buildings is sometimes custom written to account for the particular differences in subsystems, protocols, and the like. Custom conversions and accompanying software is time consuming and expensive for end-users or their consultants to develop. A software defined building object of the present disclosure is intended to group otherwise ungrouped or unassociated devices so that the group may be addressed or handled by applications together and in a consistent manner.

In a BMS controller, a conference room building object may be created in memory for each conference room in the building. Further, each conference room building object may include the same attribute, property, and/or method names. For example, each conference room may include a variable air volume box attribute, a window attribute, a lighting attribute, and a door access device attribute. Such an architecture and collection of building objects is intended to allow developers to create common code for use in buildings regardless of the type, protocol, or configuration of the underlying BMS subsystems. For example, a single automated control application may be developed to restrict ventilation to conference rooms when the conference rooms are not in use (e.g., when the occupied attribute is equal to “true”). Assuming proper middleware and communications systems, the setup or the installation of a different BMS device or an application for a different BMS may not need to involve a re-write of the application code. Instead, for example, if a new building area is designated as a conference room, a new conference room building object can be created and set-up (e.g., a variable air volume unit mapped to the conference room building object). Once a new conference room building object is created and set-up, code written for controlling or monitoring conference rooms can interact with the new conference room (and its actual BMS devices) without modification.

BMS interface (e.g., a communications interface) can be or include wired or wireless interfaces (e.g., jacks, antennas, transmitters, receivers, transceivers, wire terminals, etc.) for conducting data communications with another system or network. For example, BMS interface can include an Ethernet card and port for sending and receiving data via an Ethernet-based communications network. In another example, BMS interface includes a WiFi transceiver for communicating via a wireless communications network. BMS interface may be configured to communicate via local area networks or wide area networks (e.g., the Internet, a building WAN, etc.). BMS interface is configured to receive building management inputs from middleware or directly from one or more BMS subsystems. BMS interface can include any number of software buffers, queues, listeners, filters, translators, or other communications-supporting services.

BMS controller is further shown to include a processing circuit including a processor and memory. Processor may be a general purpose or specific purpose processor, an application specific integrated circuit (ASIC), one or more field programmable gate arrays (FPGAs), a group of processing components, or other suitable processing components. Processor is configured to execute computer code or instructions stored in memory or received from other computer readable media (e.g., CDROM, network storage, a remote server, etc.). According to an exemplary embodiment, memory is communicably connected to processor via electronic circuitry. Memory (e.g., memory unit, memory device, storage device, etc.) is one or more devices for storing data and/or computer code for completing and/or facilitating the various processes described in the present disclosure. Memory may be RAM, hard drive storage, temporary storage, non-volatile memory, flash memory, optical memory, or any other suitable memory for storing software objects and/or computer instructions. Memory may include database components, object code components, script components, or any other type of information structure for supporting the various activities and information structures described in the present disclosure. Memory, for example, includes computer code for executing (e.g., by processor) one or more processes described herein. When processor executes instructions stored in memory for completing the various activities described herein, processor generally configures BMS controller and more particularly processing circuit to complete such activities.

Memory is shown to include building objects and building object templates, which can be used to construct building objects of predefined types. For example, building object templates may contain a “Conference Room” template that can be used to define conference room objects in building objects.

For example, BMS controller 12 may group inputs from the various subsystems to create a building object including inputs from various systems controlling the environment in the room.

As an example of how a building object may be used by the system, all conference room building objects may have the same attributes as another may be listed together. They may also be grouped by location, use, risk, or other criteria. Once each of the conference rooms in building are mapped to a software defined conference room building object, the rooms may be treated the same way in code existing in BMS controller, remote applications, or UI clients. Accordingly, an engineer writing software code for UI clients, remote applications or BMS controller can know that each conference room will have attributes listed. Therefore, for example, rather than having to know an address for a particular variable air volume controller in a particular HVAC system, a given conference room's VAV controller may be available at the conference room's vav attribute.

The smart home controller may remotely gather this data to determine an occupancy state of the property. The occupancy state may indicate whether any individuals are currently located on the premises of the property, whereby the property may be deemed unoccupied if no individuals are currently located within, or in proximity to, the property or may be deemed occupied if at least one individual is located within, or in proximity to, the property. The occupancy state may also include an identity of which room the individuals located on the premises of the property are currently located.

As an example, the smart home controller may detect, via a heat sensor, a visual sensor, an infrared sensor, a sound sensor, and/or a smoke detector, that a fire is present on the property. The smart home controller may check the occupancy state of the property to determine whether any individuals need to evacuate the property. If there are any individuals on the property, the smart home controller may generate an escape route for each individual to safely evacuate the property. The smart home controller may communicate the escape routes to a mobile device associated with each individual. As a result, the mobile devices may display an interface that notifies the individual about the fire (or other emergency situation) and guides the individual along their respective escape route.

To mitigate the risk of damage to the property and/or ensure the safety of the individuals located thereon, the smart home controller may analyze the location of the smart devices compared to locations of the individual, the detected fire, and/or escape routes. The controller may then determine if the capabilities of the smart devices mitigate the risk of damage to the property or the individuals. For example, the smart home controller may transmit an instruction to a smart door that automatically causes the door to open to facilitate an easier escape. It should be appreciated that when there are multiple individuals located on the property, the smart home controller may ensure that performing the action to protect the safety of a first individual does not threaten the safety of a second individual.

The systems and methods discussed herein address a challenge that is particular to home automation. In particular, the challenge relates to a lack of user ability to effectively control certain components within a property while a fire is present. This is particularly apparent when the user is not aware of the fire and/or may not have time to manually perform actions to mitigate risks associated with the fire. For example, an individual may be located in a part of the property currently unaffected by the fire, and proper mitigation may require the individual to risk grievous bodily injury to manually perform a mitigative action. Moreover, during fire events, individuals may panic and be unable to decide on a proper course of action. Instead of requiring users to manually figure out the best way to mitigate damage to the property and/or deploy safety equipment, as required on conventional properties, the systems and methods dynamically determine the most appropriate actions to mitigate damage to the property and/or automatically adjust the operation of the smart devices accordingly. Therefore, because the systems and methods employ dynamic operation of connected devices within a property, the systems and methods are necessarily rooted in computer technology in order to overcome the noted shortcomings that specifically arise in the realm of home and/or building automation.

Similarly, the systems and methods provide improvements in a technical field, namely, home (and/or building) automation. Instead of the systems and methods merely being performed by hardware components using basic functions, the systems and methods employ complex steps that go beyond the mere concept of simply retrieving and combining data using a computer. In particular, the hardware components may compile operation data of connected devices, analyze the operation data, determine the presence of a fire, dynamically adjust device operation, generate escape routes, communicate relevant data between or among a set of devices, and/or alert emergency service providers, among other functionalities. This combination of elements impose meaningful limits in that the operations are applied to improve home automation by improving the consolidation and analysis of operation data, and by facilitating and/or enabling the efficient adjustment of connected device operation in a meaningful and effective way to mitigate risks associated with fires.

According to implementations, the systems and methods may support a dynamic, real-time or near-real-time analysis of any received sensor data. In particular, the central controller and/or insurance provider may retrieve and/or receive real-time sensor data from the smart devices, analyze the sensor data in real time, and dynamically determine a set of actions or commands based upon the analysis. Additionally, the central controller and/or insurance provider may provide, in real-time, the set of actions or commands to the smart device (and/or to another device) to perform the command to manage its operation. Accordingly, the real-time capability of the systems and methods enable the smart devices to dynamically modify their operation to mitigate risks associated with the presence of the fire on the property. Additionally, individuals associated with the property are afforded the benefit of being dynamically notified of the issues so that the individuals may take any additional or alternative mitigating actions.

The systems and methods therefore may offer a benefit by enabling homeowners to receive sufficient warning about fire events and to automatically minimize damage that may be caused by the fire. By communicating these instructions to homeowners, the smart home controller may minimize the risk of harm to devices disposed on the property and/or homeowners (and/or building occupants) themselves. Further, insurance providers may experience a reduction in the number of claims and/or a reduction in the amount claimed as a result of the mitigating the damage caused to the property by the fire, thus reducing their overall liabilities. The present systems and methods may also provide improvements, in certain aspects, to the technological fields of insurance, emergency response, appliance manufacturing, and/or urban planning.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to mechanical fire suppression systems for kitchens, embodiments of the present technology are equally applicable to various other types of fire suppression systems and fire suppression systems that may be used in other applications (e.g., in vehicular hazard areas, in computer rooms).

The techniques introduced here can be embodied as special-purpose hardware (e.g., circuitry), as programmable circuitry appropriately programmed with software and/or firmware, or as a combination of special-purpose and programmable circuitry or hardware. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Operating environment may include one or more mobile devices (e.g., a mobile phone, tablet computer, mobile media device, mobile gaming device, vehicle-based computer, wearable computing device, etc.), communications network, monitoring platform (e.g., running on one or more remote servers), fire suppression systems located in buildings, user management interface, and a customer database.

Mobile devices and the fire suppression systems located in buildings can include network communication components that enable communication with remote servers (e.g., hosting monitoring platform) or other portable electronic devices by transmitting and receiving wireless signals using licensed, semi-licensed or unlicensed spectrum over communications network. In some cases, communications network may comprise multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. Communications network can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

Those skilled in the art will appreciate that various other components (not shown) may be included in mobile devices to enable network communication. For example, a mobile device may be configured to communicate over a GSM mobile telecommunications network. As a result, the mobile device or components of the fire suppression systems may include a Subscriber Identity Module (SIM) card that stores an International Mobile Subscriber Identity (IMSI) number that is used to identify the mobile device on the GSM mobile communications network or other networks, for example, those employing 3G and/or 4G wireless protocols. If the mobile device or components of the fire suppression systems is configured to communicate over another communications network, the mobile device or components of the fire suppression systems may include other components that enable it to be identified on the other communications networks.

In some embodiments, mobile devices or components of the fire suppression systems in buildings may include components that enable them to connect to a communications network using Generic Access Network (GAN) or Unlicensed Mobile Access (UMA) standards and protocols. For example, a mobile device may include components that support Internet Protocol (IP)-based communication over a Wireless Local Area Network (WLAN) and components that enable communication with the telecommunications network over the IP-based WLAN. Mobile devices or components of the fire suppression systems may include one or more mobile applications that need to transfer data or check-in with monitoring platform.

In some embodiments, monitoring platform can be configured to receive signals regarding the state of one or more fire suppressions systems. The signals can indicate the current status of a variety of system components. For example, in accordance with some embodiments, the signals can indicate whether or not the cartridge is installed, service state of the detection line, activation of the system, sensor measurements (e.g., temperature, accelerations, etc.), and the like. In some embodiments, the fire suppression systems can monitor and report the status of the cartridge using either existing micro switches or the physical position of the cartridge. The status of the detection line can be monitored and reported using existing micro switches, tension on the line, or the position of the mechanical components on the line.

Monitoring platform can provide a centralized reporting platform for companies having multiple properties with fire suppression systems. For example, a hotel chain or restaurant chain may desire to monitor multiple properties via monitoring platform. This information can be stored in a database in one or more fire suppression profiles. Each of the fire suppression profiles can include a location of a fire suppression system, a fire suppression system identifier, a list of components of the fire suppression system, a list of sensors available on the fire suppression system, current and historical state information, contact information (e.g., phone numbers, mailing addresses, etc.), maintenance logs, and other information. By recording the maintenance logs, for example, monitoring platform can create certifiable maintenance records to third parties (e.g., insurance companies, fire marshals, etc.) which can be stored in customer database.

In some embodiments, the system identifier may be associated with some of the static information. For example, a first set of alphanumeric characters may represent the owner or business (e.g., a particular hotel chain), a second set of alphanumeric characters may represent a particular system configuration, and the like. The following table illustrates some fire suppression profiles that may be recorded on the database.

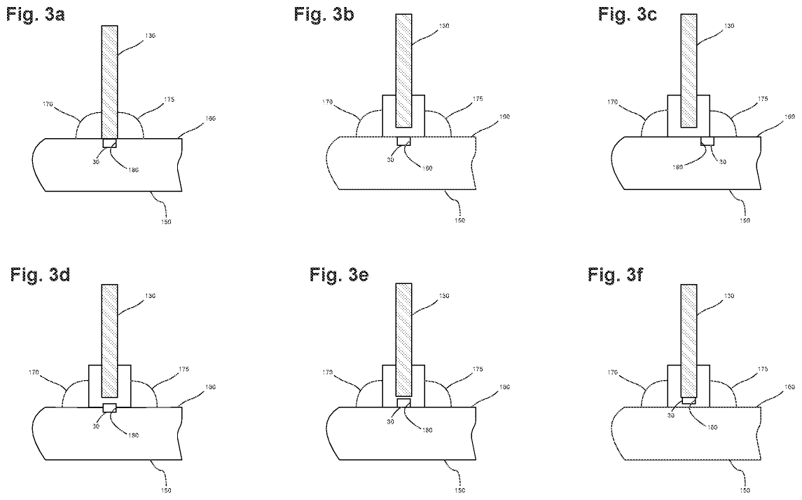

A kitchen fire suppression system may be used in accordance with one or more embodiments of the present technology. A fire suppression system may be installed for appliance (e.g., stove or other kitchen appliance). This may also be used for machines prone to fire, such as those used to shred or burn confidential documents, coffee makers, etc. Fire suppression system can include nozzle in a fixed position relative to appliance. Additional components of the fire suppression system (described in more detail in FIG. 3) can be included in enclosure. For example, enclosure can include a cartridge containing a pressurized gas and an agent tank coupled to the cartridge. The pressurized gas within the cartridge may include, for example, Nitrogen or CO₂, depending on the application. The agent tank can have a fire suppression agent stored within. The suppression agent is typically housed at atmospheric pressure in the agent tank. The agent tank can be connected to distribution piping providing a conduit that allows the fire suppression agent, when expelled from the agent tank, to flow from the agent tank to the nozzle.

A release assembly inside enclosure can be coupled to the cartridge and detection line. Detection line can extend through hood and may be enclosed. Detection line can be designed to break or melt after reaching a temperature that may be indicative of a fire. As detection line breaks, the release assembly is activated. Upon activation of the release assembly, the cartridge within enclosure releases pressurized gas causing the fire suppression agent to expel from the agent tank through the distribution piping to nozzle.

In accordance with various embodiments, one or more sensors and at least one communications module can be included within fire suppression system. The sensors can be used to measure a current state at the nozzle, the cartridge, the agent tank, the release assembly, or other component states (e.g., temperatures, pressures, flow rates, volumes, and the like).

Local processing unit or communications module can be configured to receive measurements of the current state from the one or more sensors and transmit the current state to a remote monitoring platform. In some embodiments, local processing unit or communications module can be configured to receive a bypass signal to suppress an alarm within the fire suppression system. The suppression of the alarm can allow a technician to service the fire suppression system without an alarm signal being generated and/or transmitted, and may also provide positive input that the system is being serviced.

In response to the bypass signal, alarm notifications generated by the alarm can be suppressed for a period of time (e.g., thirty minutes, one hour, two hours etc.). In some embodiments, the bypass signal can include the period of time (e.g., as selected by a technician). In other embodiments, the period of time may be fixed (e.g., five minutes, ten, minutes, one hour, etc.). The alarm notifications can include internal and external alarm signals, and the communications module can be further configured to receive an activation signal to active the alarm. In response to the activation signal, the bypass of the alarm notifications can be removed.

Local processing unit or communications module can be further configured to determine whether the one or more sensors indicate that the fire suppression system is fully functional. Upon determining that the fire suppression system is not fully functional, the fire suppression system can generate an alert to the technician that the period of time the alarm notifications will be suppressed is about to expire. These alarm notifications can be sent via local processing unit or communications module (e.g., using a short-range network or communications protocol). In some embodiments, local processing unit or communications module can directly communicate the measurements of the current state of the one or more sensors to a gateway (not shown). The gateway, upon receiving the signals, can then transmit (e.g., using a cellular or IP-based network) the current state to a remote monitoring platform.

In some embodiments, the fire suppression system can include a local memory to record the current state from the one or more sensors over a period of time. Then, local processing unit or communications module can transmit the current state over the period of time in batches to the monitoring platform. These transmissions may be prescheduled (e.g., every ten minutes, every hour, once a day, etc.) or event triggered. As one example, the system may send more frequent transmission upon determining that the appliance is in use (e.g., based on temperature readings) and then send less frequent transmissions when the applicant is determined not to be in use (e.g., in the middle of the night).

Other embodiments of the present technology may be use other types of fire suppression systems. For example, the system can be used for the continuous monitoring and protection of one or more hazard areas of a vehicle. A hazard area can be an engine compartment, a wheel well, a hydraulic equipment, a storage area for combustible materials, and/or other location of a vehicle. These systems may use a variety of different fire suppressing agents, such as, but not limited to heptafluoropropane and/or sodium bicarbonate. Some embodiments may include multiple zones of protection each having different nozzles and sensors that allow for fire protection and/or prediction. Each of the zones may have a local processing unit or communications module (e.g., communication module) can transmit the current state over the period of time in batches to the monitoring platform or to a centralized processing unit that is responsible for the vehicle. Each of the nozzles can be connected via distribution piping to an agent tank and/or pressurized canister to allow for the distribution of the agent.

Components of the fire suppression system within enclosure can include cartridge containing a pressurized gas (e.g., Nitrogen or CO₂), agent tank coupled to cartridge, and release assembly coupled to the cartridge and detection line. Agent tank can have stored within it a fire suppression agent. Agent tank can be connected to distribution piping providing a conduit that allows the fire suppression agent, when expelled from the agent tank, to flow from agent tank to nozzle via the distribution piping.

Release assembly can include one or more sensors (e.g., switches, accelerometers, scales, spring-based mechanism, etc.) to determine whether the cartridge is installed and to identify whether release assembly is loaded or unloaded. These sensors can be provided by a number of manufacturers and can be integrated into various points on the assembly or included as part of an aftermarket add-on kit. When these sensors (e.g., micro switches) are available, the system can monitor the outputs of these sensors as I/O points allowing the system to determine whether cartridge is installed and whether release assembly is loaded or unloaded. For example, in some embodiments, different logic can be provided, depending on whether the switches are normally open or normally closed.

Some embodiments may not include switches (e.g., micro switches). However, other detection mechanisms can be used. For example, cartridge can be tethered and monitored for connectivity as well as a vertical state. Some embodiments can use a counterweighted or liquid metal switch mechanism. Still yet, other embodiments could use accelerometers, gyros, or a ball switch. By affixing a sensor that can detect orientation (e.g., a ball switch) to the cartridge, the system can monitor the cartridge orientation. While in a vertical state (e.g., normal installed position), the switch can be installed/configured to be normally closed, but when removed and placed horizontally (they are cylinders with rounded bottoms so they are generally placed horizontally), it reports a normally open state.

Since maintenance is a regular occurrence, some embodiments may not create an alarm immediately when cartridge is removed. As such, the system can be programmable to add a delay (e.g., one minutes, two minutes, five minutes, ten minutes, twenty minutes, or other amount of time) after which point the system may activate local visual or audible reminder (e.g., using a piezo, buzzer, LED, etc.) to remind a technician that cartridge is still uninstalled.

A spring-based mechanism can be used in some embodiments to measure the weight of agent tank. This measurement can be indicative of whether sufficient fire suppression agent is present within agent tank. In addition, nozzle can be associated with a temperature sensor to measure a temperature at nozzle.

When the fire suppression system is in an operating state, detection line should have tension. During service, the tension on detection line is often released and could be left in the maintenance state afterwards thus leaving the system inoperable. Embodiments of the present technology can monitor the tension on detection line in a variety of ways. For example, a liquid metal or metal ball switch may be used in some embodiments. The liquid metal or metal ball switch can be affixed to an arming mechanism or part of the mechanical armature. The switch would be wired into the system as either a normally open or normally closed switch.

Some embodiments may use a proximity probe or micro switch to determine whether detection line is active. Again, the proximity probe or micro switch may be affixed to the arming mechanism (micro switch) or at the loaded or unloaded position (proximity). The option for a normally open or normally closed switch would be necessary so that multiple system configurations could be monitored. Still yet, some embodiments may use an extensometer or load cell to look at stretch or tension in the cable. In cases where springs are providing the tension on the line, the extensometer could be integrated into the spring (e.g., much like a spring-based scale that fishermen use to weigh the fish they catch). In accordance with various embodiments, the detection line state can be monitored and reported by the microprocessor. Just like the installed state of the cartridge, an alarm could be set locally on a time delay.

Some embodiments can also verify whether a sufficient amount of agent is contained in cartridge. For example, when cartridge has a tare weight that is significantly less than the weight when full with agent (e.g., less than 60%, 50%, 40%, etc.) an identification may be made that the agent is missing. In a 1a.5-gallon tank, approximately 12.5 pounds of agent is typically needed to fill agent tank; and in the 3-gallon tank approximately, 25 pounds of agent is typically needed to fill agent tank.

Some embodiments may use a load cell on which agent tank sits. Either weighing system option lets the system validate if agent tanks are in place, if the agent is there, and whether we have a 1a.5- or 3.0-gallon system (or some combination). Statistically speaking, at a global level, kitchen hood systems in aggregate activate on a weekly, if not daily, basis, yet not all fire suppression events are reported. Some system activations are the result of real fires, others are maintenance errors (technicians set them off inadvertently), and others are the result of improper or no maintenance (worn parts, wrong parts, non-OEM parts, etc.). Regardless of how the system is activated, a sequence of events can be triggered. There is the obvious event that the fire department must respond to, but following that, the kitchen and cooking equipment needs to be cleaned and inspected by the board of health. The fire suppression system needs to be serviced; at a minimum, the suppression agent needs to be replaced, a new gas cartridge needs to be installed, and links and nozzles may need to be replaced, as well. The fire marshal and insurance company may need to review and approve this work, too. If cooking equipment was damaged, it needs to be serviced and or replaced, as well. Having the ability to capture the activation in real time can start the process sooner and will improve data gathering on the real number of system activations, as well as the causes behind them.

While some of the micro switches in the system could provide an indication that a fire suppression system has discharged, they may not be conclusive. For example, tension can be released on the detection line to change the fusible links without removing the gas cartridge, and this would mimic a characteristic of a discharge event. Some embodiments monitor this state as a possible supervisory alarm, so it can't serve as an indicator of both. During a discharge, though, the detection line tension may be released quickly, when a pressure seal is broken on the cartridge, and high-pressure gas escapes and forces the liquid agent through the piping and nozzles. All of this activity makes noise and has acoustic signatures; the release and the puncture are highly identifiable metal-to-metal impacts, and the discharge produces a broader spectrum, longer duration and high-amplitude vibration. Accordingly, some embodiments may use microphones, vibration sensor, or other techniques to measure the acoustic signatures. Some embodiments, for example, may use an accelerometer placed on the cartridge, the puncture mechanism, the agent tank, or the discharge line (or any combination of these) to allow the system to determine various events and accurately identify a discharge.

Local processing unit and gateway unit can be low-power, microprocessor-based devices focused solely on a particular application. These units may include processing units, memories, I/O capabilities, audible and visual signaling devices, and external communications capabilities. For example, local processing unit can include communications module, RAM, microprocessor, power source, USB, Bluetooth, LEDs, etc. Local processing unit can communicate (e.g., wirelessly) with various sensors installed in a fire suppression system. Similarly, gateway unit can include Wi-Fi or cellular circuitry, SD card, RAM, microprocessor, power source, Ethernet, USB, Bluetooth, I/O's, communications module, etc.

Microprocessors and can have unique identifiers (IDs) programmed or set at the manufacturing level. The unique IDs can be used to link or associate local processing unit or gateway unit with customers, particular fire suppression systems, physical sites, and/or other information.

Various embodiments of local processing unit can allow a technician to configure a service delay timer. Since some systems are small (e.g., one or two tanks) and others are large (e.g., over a dozen tanks), one time delay does not work for all systems. When the cartridge is removed, the preconfigured timer starts. If the maintenance is completed within the timeframe, no warnings are issued. If the service takes longer, the unit can start to beep. The technician has the option to reset/snooze the timer by depressing a button. If the technician does not reset the alarm and it is allowed to continue for a full period (e.g., 20-minute alarm is generated for another 20 minutes), then local processing unit will notify an external server (e.g., monitoring platform) that the fire suppression system is potentially disabled and a notification can be sent to facilities management, the technician, the remote monitoring platform, and others.

During service, the tension on the detection line may be released and the cartridge may be removed. In this instance, the system still works in the same capacity, except that the second device removal restarts the timer. For example, the technician removes the cartridge, presumably weighs it, then a few minutes later releases the tension on the detection line, and that will restart the timer. When both devices are back in their normal state, the maintenance state ends and the system is considered normal again.

Upon system discharge, the microcontroller in local processing unit can search for a sequence of events and signatures. An example of one such sequence is the detection line tension is released, followed by a metal-to-metal vibration impact and a broader-range, extended vibration signature due to the discharge of gas. This signature is highly correlated to a discharge of gas. As such, when the system detects this signature indicative of a discharge of gas, the system will not know if this is a real fire, a test or human error without additional sensor data.

In the case of tests where agent is not used (just a system blowdown), the acoustic signature will change in both amplitude and frequency content (gas by itself has a different signature than gas and liquid combined). Low- and high-pass filtering techniques, along with Fast Fourier Transforms, can be used to ID the event and determine if it was a full discharge or blowdown. The ability to identify this automatically allows the system to earmark the event as a test rather than an alarm (or vice versa).

In the case of a real discharge, the system can inform the system owner and appropriate/assigned maintenance provider of the discharge via e-mail, text message, phone call or other communications protocols. The provisions can be made at the remote monitoring platform to define the discharge event as Real, Test or False Discharge (with additional details) after an inspection is performed. This allows the end user to begin recording a history, which also affords parent companies, insurance providers, and equipment manufacturers an opportunity to assess the probability and types of discharge events that are happening.

Owners and system service providers can be notified within seconds of the discharge event. User profiles enable the end user to define his or her type or types of notification and when they occur (any time versus specific times). Accordingly, the notification capabilities are not solely limited to alarm or discharge notifications. Since the system is capable of identifying maintenance activity and/or normal states, the system can be configured to notify end users, technicians and customers of said states.

Service events do not initially generate external notifications. If a service technician receives a local warning (piezo buzzing) and acknowledges the warning by depressing the button on the microcontroller, then no external warning is sent. If, however, the unit continues to sound for another predefined period of time, then we must presume that the technician has left the system in a non-operational state, and the system will send out external “System Inoperable” notifications. If an external line is not available, the system will attempt to send a message (e.g., via Bluetooth).

I/Os can be simple contact closure with a mechanical option to connect a switch to the normally open or normally closed terminals. This can help accommodate a variety of system configurations and may result in less field programming. Audible and visual warnings can be local (within the vicinity of the monitored system). For example, visual indicators may be board-based LEDs, and audible would be a buzzer or piezo. Other embodiments may also include dry or wet contacts to provide binary alarm, warning, supervisory, trouble or other alerts to secondary fire, security, building automation or like systems on site.

Local processing unit and gateway unit can have a variety of external communications. In some embodiments, these components can support serial or USB communications so that the device can be programmed, configured or interrogated. A local Ethernet port (supporting POE) may also be available in some embodiments. Additional communications options may include the ability to add a daughter board for Wi-Fi or Cellular connectivity. This component can allow all data and events local to the system to a centralized server (e.g., remote monitoring platform).

The electronics portions can support power management (light blue), input and output (grey), local storage (green—static and dynamic), communications (dark blue—standard, orange—optional) and MMI interface components (yellow). Since these fire suppression system are typically pure mechanical systems with no AC or DC power feed, power can be battery-based, with super caps and scavenging support. In the case of battery operation, Wi-Fi and Cellular communications may not feasible, so external notification may be limited to Bluetooth connectivity to the technician's phone or a local platform.

If the sensor package is installed in the enclosure, gateway unit 400 may be closer to power and or network connections. As such, some embodiments may use a battery in the sensor package and one of the three power options noted above. The local processing unit may be battery powered, but if this is the only form of power, many types of external communications may quickly drain the battery.

In case of power outage, rather than put the entire system in the fire suppression system back box, some embodiments break the system into two parts: a small communications and sensor package. The link between the two components may be a lower frequency, low-bandwidth wireless link, thus allowing us to move the higher power components closer to a power source and an Ethernet connection or better cell coverage.

Some embodiments may use LoRa® (https://www.lora-alliance.org/)—a low power wide area network that would provide an encrypted link from the fire suppression system to gateway unit. Gateway unit has the potential to interface with multiple LoRa slaves so that one gateway unit may serve as the host to multiple hood systems at a large catering or hotel complex. In addition, some embodiments may add in other items to be monitored, like refrigeration, HVAC, burglar alarms, sprinkler systems, fire extinguishers and fire alarm control panels, if necessary.

Various embodiments of the LoRa-enabled system may include at least two major components: a small sensor package (at least one) and a larger gateway unit (only one). The sensor package transmits signals from local, low-power sensors back to gateway unit where they are processed and forwarded on to an external server using the Ethernet, Wi-Fi or cellular connection. If additional systems are to be monitored at the site, a LoRa-based sensor package can be added and configured to communicate with gateway unit.

Monitoring platform can include memory, one or more processors, communications module, status module, identification module, data collection module, technician locator module, service request module, recordation module , analytics engine, prediction engine, and graphical user interface (GUI) generation module. Each of these modules can be embodied as special-purpose hardware (e.g., one or more ASICS, PLDs, FPGAs, or the like), or as programmable circuitry (e.g., one or more microprocessors, microcontrollers, or the like) appropriately programmed with software and/or firmware, or as a combination of special-purpose hardware and programmable circuitry. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, status module and identification module can be combined into a single module for determining the status of one or more fire suppression systems.

Memory can be any device, mechanism, or populated data structure used for storing information. In accordance with some embodiments of the present technology, memory can encompass any type of, but is not limited to, volatile memory, nonvolatile memory and dynamic memory. For example, memory can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory.

Memory may be used to store instructions for running one or more applications or modules on processor(s). For example, memory could be used in one or more embodiments to house all or some of the instructions needed to execute the functionality of communications module, status module, identification module, data collection module, technician locator module, service request module, recordation module, analytics engine, prediction engine and/or GUI generation module. An operating system can be used to provide a software package that is capable of managing the hardware resources of monitoring platform. The operating system can also provide common services for software applications running on processor(s).

Communications module can be configured to manage and translate any requests from external devices (e.g., mobile devices, fire suppression systems, etc.) or from graphical user interfaces into a format needed by the destination component and/or system. Similarly, communications module may be used to communicate between the system, modules, databases, or other components of monitoring platform that use different communication protocols, data formats, or messaging routines. For example, in some embodiments, communications module can receive measurements of the current state of one or more fire suppression systems. Communications module can be used to transmit status reports, alerts, logs, and other information to various devices.

Status module can determine the status of one or more fire suppression systems. For example, status module may use communications module 515 to directly request a status of a fire suppression system from one or more gateways or local processing units. Identification module can be configured to receive sensor data generated by the fire suppression system. Using the received sensor data, identification module can then identify an operational status of the fire suppression system. The operational status and/or the sensor data itself can then be recorded within a fire suppression profile in a database. As a result, the fire suppression profile can provide a history of the operational status of the fire suppression system over time. In accordance with some embodiments, the operational status can include a functional status indicating that the fire suppression system will operate as expected, a maintenance status indicating that the fire suppression system is under maintenance, a discharge status indicating that the fire suppression system has been discharged, and an inoperative status indicating that the fire suppression system will not operate as expected.

Data received via communications module can be accessed by data collection module for processing, formatting, and storage. Data collection module can keep track of the last communication from each of the fire suppression systems and generate an alert if any fire suppression system fails to report on schedule (e.g., every minute, every five minutes, or other preset schedule). Data collection module can also review the quality of the data received and identify any potential issues. For example, if a data set from a fire suppression system includes various sensor data, data collection module can analyze the data to determine any erratic behavior or outliers that may indicate that a sensor is beginning to fail.

Technician locator module can be configured to receive location and schedule updates from mobile devices associated with technicians. Service request module can be configured to identify when the operational status of the fire suppression system is inoperative and identify an available technician using the technician locator. As a technician is servicing a fire suppression system, he or she may use a computer application or a mobile application to report various findings, observations, parts replaced, and the like. As this information is transmitted to monitoring platform, recordation module can record the information from the technician in the appropriate fire suppression profile.

Analytics engine can analyze the sensor data and generate a correlation model that is predictive of when a discharge of the fire suppression system is likely. In some cases, analytics engine can use the sensor data as well as other types of information such as observations from the technicians during inspections. Prediction engine can be configured to process the sensor data in real-time against the correlation model generated by the analytics engine and generate an inspection request upon determination that the discharge of the fire suppression system is likely. In some embodiments, prediction engine can also process the sensor data in real-time against the correlation model generated by analytics engine and send a signal to the fire suppression system to automatically cutoff a gas line. Analytics engine can also monitor the sensor data and generate other types of analytics.

### II. IOT

### A. IOT Basis and Benefits

Methods and systems for generating a response to detecting a fire on a property are provided. In certain aspects a smart home controller (or other smart controller) may analyze data received from smart devices disposed on within or proximate to a property. If it is determined that a fire is present on the premises of the property, the smart home controller may determine a location of the fire as compared to the smart devices. The smart home controller may then generate and transmit instructions causing a portion of the smart devices to perform a set of actions to mitigate risks associated with the presence of the fire on the property. The smart home controller may also compare the location of the fire with a location of an occupant and generate an escape route for the occupant. Insurance policies premiums or discounts may be adjusted based upon the fire response/mitigation functionality.

A multi-unit monitoring system includes a plurality of units coupled to a communication medium. The system can also incorporate a common control element coupled to the medium. The individual units include control circuitry which is capable of carrying out verification confirmation or entry/exit delay processing. While the control element can receive messages from the various units indicative of their status the units themselves carry out the respective timing functions.

The use of IOT provides a number and variety of benefits. Firefighters speeding to the scene will know what floor the fire is on and which sensors the emergency triggered. They'll also learn how many people are in the building, and which entrance to use when they get there.

The system may allow for different actuator Capabilities. The IoT solution can allow an authorized first responder to take remote control of another device, application or service (e.g., a first responder connect to a PS IoT device and unlock doors, turn off building ventilation systems, or close a natural gas valve.

For insurance claims it may be useful to merge the data from the system with surveillance footage (from existent or system cameras) to reconstruct the origin/root cause of a fire and other details that would be obtained from synchronized ‘time-stamped’ video and sensor records. From an invention—it would be good to have this record and playback option for building owners, insurance providers, and building maintenance.

System can inform fire fighters (fire brigade) and building occupants about fire status, best escape path—or a ‘plan to follow’—this insight may be as simple as ‘stay put’ or exit for occupants versus instructing on specific exit path. There may be an opportunity to charge more in cases where buildings house individuals with disabilities (physical/mental) who may have changes with emergent situations in buildings.

The system can inform fire fighters (fire brigade) and building occupants about fire status, best escape path—or a ‘plan to follow.’ This insight may be as simple as ‘stay put’ or exit for occupants versus instructing on specific exit path.

The identifier 50 may be interrogated with a communication device 40. The communicationdevice 40 may communicate with the identifier 50 using wired or wireless technology or a combination of both. The communication device 40 may be a mobile unit 40a such as for example a hand-held scanner or it may be a hub 40b which may include a (semi-) fixed device. The communication device may also be a combination of a mobile unit 40a and ahub 40b.

In an exemplary embodiment a hub 40b interrogates one or more identifiers 30 at certain intervals. In an exemplary embodiment a building may be divided into a plurality of zones,each with their own hub 40b. The zonal hubs 40b may communicate directly or indirectly with one and other and/or with a central hub 40b.

The communication device may be able to communicate with a data storage arrangement. The data storage arrangement may be positioned in any suitable location, but preferably not in the same building it holds data on, as the data needs to be accessible incase of an ongoing fire in that building or for post-fire analysis of that building.

For each building, consideration of alternative means of building the system will need to be considered—for example, centralizing the sensor to a more general purpose camera that could assess movement of doors/windows/grills equipped with reflective stickers—and perhaps containing a communications capability for transmitting and receiving information and local alert capability (lights/sound). Such a system would reduce the number of batteries and possible points of failure as well as allowing for more powerful electronics/communications in a larger enclosure than would be afforded in the form factor of individual sensors.

The system may also consider other non-sensor signs of a fire or status of fire such as voltage and amperage changes in electrical systems, changes in water pressure and other considerations that can be fed into the system. It may sense s of life and occupancy status, continuous monitoring or snap-shot monitoring of the identity and number of humans/pets in a building. It may also contain:
Means of bi-directional or unidirectional communicating with occupants on predictive fire avoidance or fire-related incident management (detection of space heaters, smoking or other risk factors)
Providing the ability for occupants to provide information about issues surrounding fire safety element status or other items of concern
Architectural plans in a dynamic fashion with original plans and changes as they are made in mechanical, plumbing, HVAC, electrical, fire and other protective system design, interior design and other plans.
An inventory of existent fire related features with inventory of fire-doors, windows, barriers, extinguishers and other elements
A means of communicating with the fire brigade for predictive maintenance, as well as providing tracking and support of fire safety element status, occupant status/location. This communication may include a map or display or instrumentation panel showing status of the systems.

The system may trigger fire extinguishing systems (which may include sprinkler activation, use of fire extinguishers, activating fire doors, or other physical barriers, activation of local or systemic alarm systems or other fire suppressant technology) computational capacity to use predictive analytics, and use machine learning and other means of anticipating fires and or the spread of an existent fire.

### B. Augmented Reality

It is also possible the system may be enhanced through the use of augmented reality (AR).

Augmented reality is being introduced with mobile phones as well as a growing base of sophisticated AR eyewear (such as the Apple AR glasses that are rumored to be introduced in 2021 or 2022). AR can assist in this system:

Enable fire inspection to look at windows, doors, and other areas and see maintenance history, interrogate the device to determine status, operational (electronic), as well as communicating back to system any observations. AR could also be used by the occupant to know how to exit to be prepared for a fire as well as making use of AR to assist (with data provided by the system) to enable more efficient exit. This system may be shared with others so as to crowd source the information about which paths are more efficient or available for exit (much like traffic applications like Waze make use of crowd-sourced information).

Future Firefighters could make use of AR to see building features, position of occupants and other information that may be occluded by smoke, fire, fallen structures or other issues.

IoT devices and applications also support improved situational awareness at the scene of the house fire. The incident Commander may use a specialized tablet to view geographic based data, which includes aerial imagery of the structure, location of nearby fire hydrants, and other utilities (e.g., gas mains, power lines, storm water drains), the location of fire apparatus, and the location of individual firefighters (and building occupants) as they move about the scene.

Firefighters working inside the burning house may visualize a floorplan overlay as well as enhanced visualization of the floor, walls, ceiling, staircases, and other elements in their path. Data to support this display may come from existing documents and maps stored by the agency which would be supplemented by lidar scanning imagery.

Typically fire alarm control units, intrusion detection systems, mass notification systems and access control systems reside on the OT side usually managed by facilities operations. Both systems have vulnerabilities that commonly include equipment tampering as well as inside and outside threats. Firewalls and other cyber protection processes and devices can help mitigate the potential for a widespread attack and protect the individual components of the IT or OT systems. A hack could impair or disable alarm systems, leading to a malfunction in the event of a real emergency. A distributed denial of service (DDoS) attack could overwhelm a server, service or network and take down the entire alarm system or affect other infrastructure. These attacks could be malicious, directed or simply the result of poor cybersecurity implementation. While most breaches target personal or commercial outlets, any hack that affects a life safety system can be a real hazard

### C. Cybersecurity Considerations

Cyber risk must be addressed through an ongoing security vulnerability assessment (SVA). Not all cases are the same, and some SVAs can take on reasonable risks while others require increased attention to mitigate calculated or known risks.

In the United States, the National Fire Protection Association (NPFA) Code 72 (National Fire Alarm and Signaling Code) describes reacceptance testing of equipment and systems when site-specific or executive software changes have been made and the equipment is commissioned and already in use. Site specific software update requires a 100% test of all functions known to be affected by the change. Currently, 10% of initiating devices that are not directly affected by the change (up to 50 devices) must be tested to verify correct system operation and a record of completion must be kept. These commonsense requirements help ensure full integrity of software changes. However, it would be challenging for any end user or code authority to directly verify that the software changes did not affect the integrity or operation of the system or equipment without additional testing or investigation. Third-party validation, reconfirmation and field testing is crucial. NFPA 72 is currently undergoing a public revision process for its 2022 edition. Topics of interest may include adding a new cybersecurity section and retesting of existing equipment upon software updates that may relate to cybersecurity functionalities.

Fire alarm control units may include two types of software: executive software and site-specific software. These applications are covered by UL 864, the Standard for Safety of Control Units and Accessories for Fire Alarm Systems, and NFPA 72. Under part of UL 864, third-party certifiers execute and test the equipment's software for integrity of normal operation. UL 5500, the& Standard for Safety for Remote Software Updates, covers best practices for software patches and updates. UL 5500 offers guidance on technical attributes necessary for the remote connection to smart devices and safe functionalities and securely executing remote software downloads. Most smart systems rely on the ability to update software remotely or onsite. UL 5500 applies to these applications in conjunction with the product's end standard.

On the international side, the International Electrotechnical Commission (IEC) has written a series of cybersecurity standards. IEC 62443-4-2 applies to industrial automation and control systems. This document applies to many of the IT and OT systems that should be considered for building cyber resiliency of smart buildings and systems.

The National Institute of Standards and Technology (NIST) has published several documents and frameworks that advise on best practices for interconnected industrial equipment and critical infrastructures.

China pays very much attention to the standards of IOT. From 2000 to 2010, Standardization Administration of PRC has founded RFID tag national standards working group, sensor network standards working group, TC10 as well as China IOT standards joint working group.

There could be an additional ‘monitoring’ fee that a landlord could charge for this more sophisticated safety system. In addition, there is an option to layer in the ability to allow occupants to opt-in to being tracked by the system so the system would know their whereabouts in the case of an emergency.

### C. SAAS

There can also be an option for additional SaaS-based fees for fire-related systems:
Inventory Tracking
Maintenance Scheduling
Fire brigade systems to assist in building monitoring and responses
Systems to allow occupants to report building-related and fire-safety related issues—making use of tagging systems (using QR codes, RFID, or augmented reality systems for fire)
The concept of a QR code that can be placed on doors (also consider other similar tech like microdots, RFID, and even a printed code) that can allow anyone in the building (perhaps with use of a specialized app) to scan and enter ‘error’ information about need for maintaining a door, window, or other structure along with commentary of the subject of concern.
There could be a menu of common issues that would be dependent on the structure in question. The app could also provide feedback if this is a new comment/concern or one in progress—potentially with anticipated ‘fix timing.’
The QR code system can be extended to non-company assets—such as fire extinguishers—to alert about charge/functional status as well as other third-party assets in a building.
Systems to provide replacement parts—structure-specific vendor-related materials

‘Marketplace’ that would enable proactive monitoring and anticipating replacements (like HP does in their printer line for toner and parts). There could be an entire supply chain associated with this idea including pick-up and delivery. At minimum, there could be ‘affinity’ programs that would make money from when 3rd party (or its own) products are ordered. Firmware and other the air/or wired updates could also be affected as part of the maintenance and monitoring service offering.

### F. High-Risk Equipment

The present invention could be used in residential, commercial, and other settings such as high fire risk locations and equipment such as kitchen equipment. In addition to equipment (e.g., kitchen equipment or other fire-prone equipment), the supervisory controller may also be connected to various other building systems, such as an HVAC system, a power/electrical system, a refrigeration system, a fire alarm/sprinkler system, a lighting system, a security system, and any other applicable communicating building systems at the site. The supervisory controller may monitor and/or control the various building systems through communication with corresponding controllers for each of the building systems. Alternatively, the supervisory controller may be, for example, an E2 Facility Management System controller also available from Emerson Climate Technologies Retail Solutions, Inc., or a similar facility or site supervisor controller, or other controller, with the operational and communication functionality as described.

In addition to communicating with the kitchen equipment and the various building systems, the supervisory controller may also monitor and receive environmental data generated by environmental sensors. For example, the environmental sensors may include an indoor ambient temperature sensor, an outdoor ambient temperature sensor, and one or more other sensors that sense environmental conditions. For example, the one or more other sensors may include a humidity sensor, a pressure sensor, a dew point sensor, and/or a light level sensor. Alternatively, the supervisory controller may monitor and receive environmental data, such as indoor and outdoor ambient temperature data, humidity data, pressure data, and dew point data, from the HVAC system or the refrigeration system. Further, the supervisory controller may monitor and receive environmental data, such as light level data from the lighting system.

The supervisory controller is in communication with a remote monitor, which can be located at a central location remote from the site. For example, the remote monitor may communicate with the supervisory controller via a wide area network (WAN) such as the Internet or via cellular communication. Alternatively, the remote monitor can be located at the site and may communicate with the supervisory controller via the site's LAN.

The remote monitor receives and monitors data from the supervisory controller, including data related to the kitchen equipment and each of the various building systems. In addition, as discussed in further detail below, the remote monitor can communicate updates to the supervisory controller for the kitchen equipment and the various building systems. The remote monitor can communicate menu and firmware updates to the supervisory controller for communication to, and installation at, the kitchen equipment.

The remote monitor is in communication with a remote terminal. The remote terminal may be, for example, a computing device, such as a desktop, laptop, tablet, or mobile computing device, operated by a user. For example, the user may utilize the remote terminal to login to the remote monitor and review associated data collected from various sites associated with the user. For example, the user may be an administrator for a food services company, such as a restaurant chain, and may login to the remote monitor via the remote terminal to review data collected from some or all of the sites associated with the food services company. As described in further detail below, the user may use the remote terminal to generate updated menus or firmware for particular kitchen equipment and to communicate the updated menus or firmware to the remote monitor for communication to the supervisory controller for communication to and installation at the kitchen equipment.

The user may be located at a site or may be located at a location remote from both the site and the remote monitor. In such case, the remote terminal may communicate with the remote monitor via a WAN such as the Internet or via cellular communication. If the remote terminal is at the same location as the remote monitor, the remote terminal may communicate with the remote monitor over a LAN accessible to both the remote monitor and the remote terminal.

The remote monitor may be in communication with multiple supervisory controllers located at multiple sites. For example, a food services company, such as a restaurant chain, may have multiple restaurants located at multiples sites, each with an associated supervisory controller in communication with the remote monitor. Residential real estate investors may do the same for various apartment complexes, houses, etc. owned by the same person or company.

Kitchen equipment may include multiple individual pieces of kitchen equipment. For example, the kitchen equipment at a particular site may include an oven, a first fryer, a second fryer, a fume hood, a drink/shake maker, and any other kitchen equipment utilized for food preparation, or otherwise, at the site. For example, other kitchen equipment may also include stoves, grills, griddles, microwaves, slicers, blenders, food processors, mixers, etc. Any combination of kitchen equipment, utilizing additional or fewer pieces of individual items, can be used. Each of the individual pieces of kitchen equipment is in communication with the supervisory controller. As discussed above, communication from the individual pieces of kitchen equipment to the supervisory controller may be accomplished via a wired or wireless connection, for example, over a LAN associated with the particular site.

The input device and the display device may be a combination touchscreen device. Alternatively, the display device may be a display screen and the input device may include buttons positioned alongside the display device. Alternatively, the display device may be an indicator, such as a light. The input device and display device, whether separate or together as a combination touchscreen device, may provide a user interface whereby output is provided to a user and input is received from a user.

The user interface device may be configured for communication with the communication module of the kitchen equipment, in this case the oven. The user interface device may communicate with the communication module of the oven through the supervisory controller. In this way, the user interface device may receive user input and communicate the user input to the supervisory controller for communication to the oven. The oven may, likewise, communicate output to the supervisory controller, which is then communicated to the user interface device for display to the user. The user interface device may serve as a communication bridge between the oven and the supervisory controller. In this way the user interface device may communicate directly with each of the oven and the supervisory controller, while the oven and the supervisory controller communicate with each other through the user interface device.

The control module may receive temperature or electrical data from equipment and set off an alarm or notify the appropriate authorities. This can apply to high risk equipment (example, kitchen equipment) or other machines or spaces deemed to be high risk.

Once the oven reaches the indicated cook temperature, the control module may control the display device or the user interface device to display an indication that the oven is ready and has reached the appropriate cook temperature. The user may then insert the food item into the oven and press a “start” button on the input device or the user interface device to start cooking the food item. Alternatively, the oven may include a door sensor and may initiate the cook time period based on an opening and closing of the oven door after the oven has been preheated. The control module may then monitor the cook time by monitoring the time period from when the “start” button was selected or from when the oven door was opened and closed. Once the cook time has been reached, the control module may control the display device or the user interface device to indicate that the cooking has completed. Alternatively, the oven may include another output device, such as an audio output device, such that the control module can control the audio output device to buzz or ring when the cooking has completed. Once the cooking has completed, the user may remove the food item from the oven and the oven may then wait for the next food item to be selected from the user interface for preparation.

Further, each of the pieces of kitchen equipment may include an associated memory that stores associated operating parameters, for example cook temperatures, cook times, or other data, used by the piece of kitchen equipment for use in preparing food. As a further example, if the kitchen equipment is a grill with top and bottom grill plates, the operating parameters may include a time or pressure for the top grill plate to be lowed onto the food item. Additionally, the operating parameters may include a length of time or amount or pressure of steam to be applied to the food item. Any other associated data utilized by kitchen equipment in preparing food items or related operations may be stored in the associated memory and utilized by the control module upon an appropriate selection being received from the user interface and input device.

Through communication with the supervisory controller, the control module may receive updated menus and/or updated firmware for storage in the memory. For example, the updated menus may include additions to or deletions from the listed food items. Alternatively, the updated menus may include new menu structures such that selection of a food item results in a second nested menu that includes various options associated with the selected food item. Additionally, the updated menu may include revisions or updates to the operating parameters, such as modifications to the cook times or cook temperatures. Additionally, the updated menu may include updated icons or updated text descriptions for display in a user interface. When updated menus and/or updated firmware are received by the control module from the supervisory controller, the control module may install the updated menus and/or updated firmware. For example, the control module may set a flag indicating that updated menus and/or updated firmware are available and stored in memory, such that upon startup the updated menus and/or updated firmware are installed. The control module may install the updated menus and/or updated firmware upon receipt, upon the next startup, or at a designated time, such as upon shutdown at the end of a business day. As discussed further below, once the updated menus and/or updated firmware are installed, the control module may communicate a confirmation message back to the supervisory controller. If an error occurred during the installation, the control module may communicate an error message back to the supervisory controller.

In addition to communication related to updated menus and firmware, the control module may also communicate usage and energy data to the supervisory controller. For example, the control module may log cook times and temperatures and periodically, for example once per day, week, or month, the control module may communicate a usage log to the supervisory controller. Additionally, the control module may monitor electrical data, such as electrical power data, electrical current data, or electrical voltage data received from one or more electrical sensors and may communicate the electrical energy data to the supervisory controller. The supervisory controller may communicate the usage and energy data to the remote monitor for additional review and analysis for reporting and diagnostics purposes. Additionally, if the kitchen equipment utilizes gas, water, or other resources, data related to the gas, water, or other resource usage may be communicated by the control module to the supervisory controller.

The supervisory controller may include a menu/firmware update module for operations and communication related to receiving updated menus and firmware from the remote monitor and communicating the updated menus and firmware to the kitchen equipment. Additionally, the supervisory controller may include one or more modules for operations and communications associated with the various building systems. Additionally, the supervisory controller may include a usage/energy/site data monitor module for operations and communications related to receiving, monitoring, and communicating usage, energy, and other site data from the kitchen equipment, building systems, and environmental sensors to the remote monitor. Additionally, the supervisory controller includes a communication module for operations associated with communicating with the kitchen equipment, building systems, and the remote monitor.

Additionally, the supervisory controller includes a memory that stores, for example, information needed for the various operations and communications described. For example, the memory may include a listing of all pieces of communicating kitchen equipment at the site, including identification information. Such identification information, for example, may include a unique network identification, a serial number, a model number, and/or other identifying information. In this way, the supervisory controller is able to track and monitor all communicating equipment, such as communicating kitchen equipment, located and in operation at the site. As equipment joins or leaves the system, the supervisory controller updates the memory and equipment listing as appropriate. For example, each piece of kitchen equipment may include a unique identification, such as a serial number, stored in memory, along with model, manufacturer, and other associated information. As described in further detail below, the supervisory controller may retrieve the identification information for all connected kitchen equipment and build an asset list of kitchen equipment located at the associated site. The supervisory controller may also retrieve the associated model, manufacturer, and other associated information for the connected kitchen equipment. The asset list and associated information may then be communicated to a remote monitor to populate an enterprise wide equipment database stored at the remote monitor, as described in further detail below.

The remote monitor may include a menu/firmware management module for operations and communication related to receiving updated menus and firmware from the remote terminal and communicating the updated menus and firmware to the supervisory controller. Additionally, the remote monitor includes an energy management module for operations and communication related to reviewing and analyzing energy and usage data from the supervisory controller and generating energy reports, recommendations, and analysis based on the received energy data. Additionally, the remote monitor includes a maintenance management module for operations and communications related to reviewing and analyzing energy and usage data from the supervisory controller and generating maintenance alerts, recommendations, and reports for scheduled maintenance and/or predictive maintenance. Additionally, the remote monitor includes a communication module for operations associated with communicating with the supervisory controller and the remote terminal.

Additionally, the remote monitor includes an equipment database. The equipment database includes a listing of the various pieces of kitchen equipment, including all associated identification information and the particular associated site locations. As described above, asset information may be received from each of the connected supervisory controllers. In this way, if updated menus or firmware are received for a particular model or type of kitchen equipment, the remote monitor can access the equipment database to determine the particular supervisory controllers that need to receive the updated menus or firmware for installation at the particular equipment.

A control algorithm may be performed by a control module associated with a particular piece of kitchen or other equipment. While the particular components of the ovens are referenced here for purposes of illustration, any particular piece of kitchen equipment, with an associated control module, can perform the algorithm. The control algorithm may be performed by the control module upon startup or shutdown of the kitchen equipment or at a scheduled or instructed time. The control module checks for updated menus and firmware. For example, the control module can check to determine whether updated menus or firmware have been received from the supervisory controller and copied into memory.

The control module determines whether updates menus or firmware are available. When updated menus or firmware are available, the control module proceeds to and installs the updated menus or firmware, as appropriate.

The control algorithm may communicate with equipment. The control algorithm may be performed by a supervisory controller upon installation or initialization of the supervisory controller. Additionally, control algorithm may be periodically repeated, as necessary. The supervisory controller checks for connected and communicating kitchen equipment devices. For example, the supervisory controller may send out a request for response to all devices on the network and may wait to receive replies. For each connected and communicating kitchen equipment device on the network, the supervisory controller may request and then receive associated identification information for the particular piece of kitchen equipment. For example, the replies from the equipment may include associated identification information for the particular piece of equipment, such as serial number, manufacturer, and/or model name, number or type information. The supervisory controller may store the identification information in the supervisory controller's memory. In addition, the supervisory controller sends the received identification information to the remote monitor for storage in the equipment database.

IOT describes a network of objects embedded with various technologies are used to pass information and perceive their environments independently. IOT has three main characteristics: fully perceivable, reliable transmission, and information processing. These three characteristics precisely match fire surveillance, alarming, and disposal practicing in firefighting management. Thus, it is clear that IOT may be built into a firefighting system to ensure that fires are adequately perceived, information is passed on, and information is processed. IOT can be divided into three layers in terms of technological framework: perception, network, and application. The perception layer is used mainly for identifying objects and collecting information. Most commonly, the perception layer is made up of devices embedded with sensors and other identifiers. The perception layer is the foundation for the application and development of IOT, as it determines the physical address of objects via unique identification, and perceives the environment via the transmission of sensors The network layer of IOT can include a variety of communication networks, such as mobile communication, internet, and satellite. The main purpose of the IOT network layer is to transmit and process information sent by the perception layer. Simply put, the network layer passes information gathered at the perception layer to a number of destinations. Finally, the IOT application layer includes internet development and the target of service and serves as the source of profit for IOT industrial chains. The application layer processes data from the perception layer with software development and other technology.

Simply, the perception layer of IOT is where information is gathered, the network layer is where information is passed, and the application layer is where information is processed and used to make a decision or develop a solution. Fire control follows a similar structure. Information about a fire is first gathered, through a variety of reporting methods, most notably and commonly being via an emergency call. Following the identification of a fire, information is passed from emergency dispatch to fire departments. Finally, the fire department uses this information from dispatch to identify the resources needed in the situation, and acts to extinguish the fire. This is the most common way fires are extinguished and fire emergencies are resolved. In some instances, wherein IOT technology is used in fire control, sensors identifying fire emergencies may be in place. Such sensors may then pass information to an alarm system which notifies building tenants of fire, or may pass information to local fire departments, who may then arrive to extinguish the fire. Thus, this technology is only actively used during a fire emergency.

However, it may be advantageous to provide a solution in which IOT technology is used prior to the event of a fire, as a way of preventing, as well as controlling, fires. As mentioned above, fire barriers such as fire doors are vital to containing the spread of fires. Inspections are performed annually, in most cases, to identify and repair any damage done to the doors. Any damage to the fire doors renders them useless, thus these inspections are extremely important to the building's fire safety. Because damage can be inflicted upon fire barriers between inspections, and some damage can go unnoticed during poor quality inspections, a solution in which fire barriers are being constantly monitored may be beneficial. In such a solution, IOT technology can be constantly at work to identify and report damage to doors prior to fire emergencies ad remain at work to report door status during said fire emergencies.

The first level of IOT is the perception level, wherein sensors and other identifiers are used to collect information. In the proposed solution, sensors located on the doors or similar fire barriers may be present as part of the perception level, identifying any damage to the barriers and constantly monitoring them to collect information on the status of the door.

In many embodiments of the solution, there may be at least two sensors located on each fire barrier. The first of these sensors may be located near the door's lock or handle and may collect a variety of information from the door. First, the sensor may verify that the door's closer is working. If the door is not closed, it is useless in a fire emergency. A fire door must be completely closed in order to adequately block fires from spreading. If the closer is damaged or otherwise non-operational, the door may not be able to fully close. If the door is left even slightly ajar, there may exist space wherein fire may pass through openings. Thus, by verifying that the door's closer is operational and not damaged, the possibility of fire making its way through openings in the door is diminished. In some embodiments, a separate door closer sensor may be required or desired to perform this verification. In such embodiments, the sensor may be located on or near the closer and may connect to the main sensor to provide information on the status of the door. In other embodiments, the closer sensor may be built into the door's main sensor. In embodiments wherein a separate sensor is required or desired, such a sensor may wirelessly communicate with the main sensor and main monitoring system.

### III. Industrial Applicability

### A. General Industrial Applicability

Significant investments focusing on technological advancements, the introduction of addressable and wireless communication system has reduced the possibility of false alarms and has been a key to progress in the response time. For instance, in January 2020, Gent's Response Plus paging solution was integrated with Honeywell's Vigilon fire alarm & detection system at school premises. The solution is expected to reduce the response time by alerting the school caretakers and authorities with instant fire hazard notifications and the nearest location details. Hence, the upgradation in fire alarm & detection systems is anticipated to improve safety, which in turn, would increase its demand across various sectors.

While the example embodiment depicted here is a single threaded example, those skilled in the art of developing systems to communicate with a plurality of physical devices will recognize that a multi-threaded approach may also be utilized. One potential embodiment of such a multi-threaded system for data harvesting may also employ a thread-monitor or scheduler that would measure the data harvesting progress in real time and increase or decrease the number of threads utilized by the system in order to achieve the most efficient utilization of network communication and processor capacity.

The read strategy may be implemented to account for various delays in gathering the requested data from various end-point devices. Examples of such delay may be due to a device being off-line, routing errors in the communication network, other processing burdens on the server engine that interrupted the data collection, or any other delay typically associated with network based communications.

For example, a one-minute trend that is off by twenty seconds may be considered to be a worse situation than a one-hour trend off by five minutes. To allow this tolerance the priority of data log commands should be modifiable by the user to allow for more precise tuning or to accommodate the specific needs of the system. This example gives a priority to higher-frequency trends without totally sacrificing the sampling of data points with longer samples. While other priority mechanisms may be accomplished by adjusting the precision percentage, or by using fixed time limits, separate queues, or more queue labels that would prioritize the most important data sample frequencies. Again, these time limits may be adjusted by the user of the system or set to a fixed priority scheme by a manufacturer in order to achieve a specific performance metric with known equipment.

Another alternative embodiment may include the throttling or shaping the amount of data to be retrieved from a particular BAS end device in a given time slot. While this approach may depend on the capabilities of a given piece of equipment, in those cases where an intelligent end device is able to understand or comply with a request for a limited subset of all of the sensor data available to it additional data collection management may be employed. For example, if a BAS network is experiencing an unusually high volume of traffic the system control mechanism may direct some data collection tasks to only gather high priority data, or a reduced data payload from a devices of a certain type or specific location in the system. This embodiment may also have the capability to direct a unique individual device to provide only a certain type or amount of data. Again, these capabilities are flexible enough to accommodate a wide variety of sensors, controls, and equipment, regardless of their communication speeds or programmability.

The foregoing descriptions present numerous specific details that provide a thorough understanding of various embodiments of some embodiments. It will be apparent to one skilled in the art that various embodiments, having been disclosed herein, may be practiced without some or all of these specific details. In other instances, known components have not been described in detail in order to avoid unnecessarily obscuring the present invention. It is to be understood that even though numerous characteristics and advantages of various embodiments are set forth in the foregoing description, together with details of the structure and function of various embodiments, this disclosure is illustrative only and not restrictive. Other embodiments may be constructed that nevertheless employ the principles and spirit of the present invention.

### B. Contamination Tracking for Laboratories, Hospitals and Other Settings

The software's recognition of contamination events and other actions may trigger parent-child relationships to other pieces of equipment and products and the analysis of a continuous stream of data from the cameras may initiate additional correlations of the individual and contaminated products as the individual moves within a monitored area. The interface summary and detection data may be printed to a report, burned to an electronic chip, or compact disc or other storage device or stored in a computer database and referenced by a unique identifier including name, contamination event classification, CCE type, and/or location.

Image data can be processed using video content analysis (VCA) techniques. The computer system may use one or more Item Recognition Modules (IRM) to process image data for the recognition of a particular individual or other object in motion, and/or an article of CCE. In addition, the computer system may use one or more Location Recognition Module (LRM) to determine the location of a particular individual or other object in motion, or an article of CCE. In addition, the computer system may use one or more Movement Recognition Modules (MRM) to process movement data for the recognition of a particular individual or other object in motion, or article of CCE. The computer may use IRM in combination with LRM and/or MRM in identifying and tracking movements of particular individual or other object in motion, or article of CCE for the purpose of assessing velocity of movement and/or conformational movement characteristics, as well as in assessing whether contamination control requirements are being violated. The IRM, LRM, and MRM can be configured to operate independently or in conjunction with one another.

The image data can be analyzed using human classification techniques that can be employed for the purpose of confirming whether an object is a human, as well as for analyzing the facial features. As used herein, the phrase “production area” refers to any area in which machines and/or individuals work in an environment to make any form of measurable progress. While a typical production area would be a factory in which articles of manufacture are being produced, the phrase “production area” includes restaurants, hospitals, gas stations, construction sites, offices, hospitals, etc., i.e., anywhere a product is being produced and/or a service is being rendered. The criteria for controlling contamination of a production area depend upon the particular nature of the production area, i.e., what articles are being produced and/or services offered, and the contamination control requirements associated with those products and/or services. Optionally, a production area can contain one or more work zones, with each work zone having different standards for the occurrence of a contamination event. The monitoring and control of contamination in different work zones can be carried out in a manner designed to monitor and control different kinds of contamination events in the different work zones.

The system may also be used to track disease spread and biological contamination in medical, laboratory, or other settings. The terms “contamination” and “contaminant” refer to any undesired substance or article released into the production area, i.e., any substance or article (including particulates) having the potential to adversely affect a product being produced, adversely affect the production equipment, adversely affect the production process, or adversely affect the production environment itself, i.e., floors, walls, ceiling, atmosphere, etc.

The phrases “contamination event” and “contamination-releasing event” and “contamination activity” refer to event(s) in which a contaminant is released into a production area in a manner so that it adversely affects a product, production equipment, the production process, or the production environment. Examples of contamination events include the release of germs by individuals in the production area, e.g., by coughing, sneezing, sweating, spitting, bleeding, vomiting, belching, crying, excreting, etc. Contamination events include other kinds of individual action in the production area, such as spilling, breaking, dropping, touching, breathing on, etc.

Contamination events also include events that occur in the production area without involving the direct action of an individual, such as a pipe leaking or breaking with a resulting release of the contents, a light bulb exploding releasing glass fragments (and possibly additional contaminates) into the production area, and/or production equipment degrading or breaking in some manner that releases one or more substances, parts, or fragments so as to potentially contaminate product passing through a production line or production equipment operating in the production area.

Contamination events also include actions outside the production area that cause the release of a contaminant into or within the production area, such as a fire or other event outside the production area releasing atmospheric particulates into the environment of the production area, vibration absorbed by the production area releasing particulates from one or more surfaces within the production area, a lightning strike into or near the production area causing a contaminate to be released into the production area, high winds buffeting the production area causing the release of particulates and/or fragments from one or more surfaces bounding the production area to within the production area, etc.

The automated monitoring and control system can be designed to automatically detect, monitor, and control a wide variety of contaminants that may be released into the production area. As used herein, the phrase “germ-releasing event” refers to any event, gesture, movement by an individual in the production area that releases germs on or within the individual into the production area. As used herein, the phrase “germ-spreading event” refers to any means of spreading germs from one surface to another in the production area.

Contamination events include all events in which are detected and recognized by the automated monitoring and control system as spreading a contaminant into product, equipment, or the production environment. Contamination events are events that have been deemed to have a likelihood of releasing one or more contaminants into the production area in a manner that has a potentially adverse effect upon product being produced, production equipment, production process, production environment, etc.

A contamination event can be addressed by contamination control equipment. For example, a face mask can serve as contamination control to prevent a contamination event from a sneeze or cough, so long as the face mask is present and properly positioned on the individual during the sneeze or cough.

Automated contamination monitoring and control can be established for virtually all foreseeable contamination events. Different kinds of contamination events and different kinds of contamination require different means for monitoring and control thereof.

“Contamination control” is inclusive of actions designed to achieve immediate reduction, minimization, isolation or elimination of the contamination, as well as actions designed to achieve a more delayed reduction, minimization, or elimination of contamination. Actions providing relatively immediate contamination control, include, for example: (i) placing a shield around one or more products to prevent contamination from reaching the product(s), (ii) placing a shield around an individual to prevent contamination emitted by the individual from spreading within the production area, (iii) cutting off power to production equipment to allow the production area to be sterilized and contaminated product removed or decontaminated, before re-starting the production equipment, and (iv) the activation of an alarm upon the occurrence of the contamination event. Contamination control can also include tracking of contaminated or potentially contaminated products and/or production equipment and/or individuals, and can include marking tracked products and taking measures to dispose of, sanitize, or otherwise resolve the contamination of products, equipment, and individuals.

As used herein, the phrase “contamination control device” refers to any device designed to control one or more contaminants in the production area, i.e., to in some manner reduce, minimize, isolate, sterilize, or eliminate one or more contaminants in the production area. A contamination control device may also take action to control production equipment, products, and/or individuals within the production area. A contamination control device may take controlling action in advance of a contamination event or, more commonly, in response to the detection of a contamination event.

An example of contamination control actions designed to achieve a more delayed reduction, minimization, or elimination of contamination include, for example, the preparation of a report identifying a contamination event (or contamination event) in the production area. The action can optionally further include transmission of the report to production supervision and production management, as well as to the individual responsible for the contamination event. Thus, the phrase “contamination control device” is also inclusive of devices that take no action other than the generation of a report revealing the presence (or absence) of contamination events in a production area over a time period. Such a report is available to inform management of any contamination events that may have occurred (or the absence of such events), so that management may take appropriate action to minimize future contamination events and/or to control the impact of contamination events that have occurred in the past and/or maintain a desired minimum level of occurrence of contamination events. Of course, the contamination control device can include means for transmitting the report to management.

A contamination control device can be activated so that it acts in a manner “in accordance with” the processed image data. For example, if the image data shows no contamination event, the contamination control device could be a report showing no contamination event by the individual during the period in which the image data is captured. On the other hand, if the image data shows a contamination event, the system can activate a contamination control device that actively addresses the contamination with any active means of contamination control, as set forth above.

As used herein, the phrase “work zone” refers to a discrete area that can correspond with an entire production area, one or more discrete regions of a production area, or even an entire production area plus an additional area. Different regions within a production area can have different germ control and contamination control requirements. For example, a first work zone could include only a defined area immediately surrounding a particular cutting board or machine in a factory. The germ-releasing events and control requirements for the machine operator and others within a specified distance of the machine may be greater than the contamination control requirements just a few meters away from the machine. A building can have many different work zones within a single area, such as 2-100 work zones, 2-50 work zones, or 2-10 work zones. Alternatively, a factory can have uniform germ-releasing event characteristics or CCE requirements throughout the production area, which can be one single work zone. This also applies to businesses and residential buildings.

As used herein, the phrase “contamination control equipment” (i.e., “CCE”) refers to any article to be worn by an individual for the purpose of controlling the emission of germs from the individual into the production environment. As such, articles of CCE include face masks, suit, napkins, tissues, etc.

As used herein, the phrase “contamination control device” (i.e., “CC device”) also includes any device that, when activated, is designed to prevent, reduce the likelihood of, or reduce the degree of, the release of germs from the individual into the production area. The CC device can be designed to immediately prevent the release of germs and/or reduce the likelihood of the release of germs, and/or reduce the degree of contamination released by the individual.

For example, the activation of the CC device when detecting a germ-releasing event could discontinue power to a machine, or interject a physical barrier or restraint between an individual and product that could be contaminated by germs. Alternatively, the CC device could provide a more delayed effect on prevention or reduction of contamination. For example, the CC device could be in the form of an alarm to alert one or more individuals of the germ contamination associated with the germ-releasing event within the production area. The individuals could be left to decide how to address the condition in response to the alarm. Alternatively, the CC device could generate and transmit a report to a production manager, agent, safety officer, etc., for the purpose of modifying behavior so that the presence of a germ-releasing event, absence of the required article of CCE, shipping of a germ contaminated article would be less likely to occur at present or in the future.

As used herein, the term “movement” includes movements of objects in which the location of the center of gravity of the individual or object changes, as well as movements in which the center of gravity does not change, but the conformation of the individual or object changes. Changes in the location of the center of gravity of an individual or object in an ascertainable time period correlate with the velocity of the individual or object. “Conformational movements” are movements in which there is a substantial change in the location of at least a portion of the individual or object, but only a small (or no) change in the location of the center of gravity of the individual or object.

The automated process for monitoring and controlling germ-releasing events and the germ contamination of food, products, or machinery in a production area utilizes algorithm-based computer vision to: identify an individual or a portion of an individual; identify whether a germ-releasing event such as sneezing, coughing, vomiting, sweating, crying, bleeding, or spitting etc. has occurred, a required article of CCE is present in association with the individual or the portion of the individual, and/or determine whether the individual or portion of the individual has the required article of CCE properly positioned thereon; identify whether a required article of CCE is present in association with the individual or the portion of the individual, and/or determine whether the individual or portion of the individual has the required article of CCE properly positioned thereon; send a signal to automatically activate a CC device in the event that a germ-releasing event has occurred and in some cases that the required article of CCE is not present in association with the individual or the portion of the individual, and/or that the required article of CCE is not properly positioned on the individual or portion of the individual,

As used herein, the phrase “contamination zone” refers to a volume encompassing the location of the contamination event, within which volume product articles and processing articles are in close enough proximity to be at risk of contamination from the contamination event. Of course, the location, size, and shape of the contamination zone depend upon the nature of the contamination (including the size and type of contamination event), the nature of the product articles and production articles in the vicinity of the contamination event, and the environmental conditions surrounding the location at which the contamination event occurs.

One or more embodiments of the present invention now will be described with reference to the accompanying drawings, in which some, but not all embodiments are shown. The invention may be embodied in many different forms and should not be construed as limited to the embodiments set forth herein. Rather, these embodiments are provided so that this disclosure will satisfy applicable legal requirements. Like numbers refer to like elements throughout.

The system may monitor contamination in an area through the monitoring of contamination events such as sneezing, coughing, vomiting, sweating, crying, bleeding, spitting, pipe leakage, machine fragmentation, etc., control of the wearing of one or more articles of CCE by one or more individuals in the production area or presence of other CCE, the tracking of items contaminated by the contamination event, as well as controlling contamination of the production area including any products that may be contaminated, any production equipment that may be contaminated, and any portion of the production environment that may be contaminated.

The control of the contamination can take any of a wide variety of forms, including marking, shielding, and/or sanitizing any contaminated or potentially contaminated products and/or production equipment and/or portions of the production area. Contamination control can also be more long range control, such as by the preparation and transmission of a report of the contamination event and data related to the contamination event, including one or more images of the contamination event and/or one or more images of contaminated products, equipment, etc. Contamination control can also utilize marking and/or tracking of contaminated or potentially contaminated products and production equipment that are in motion in the production area.

Computer vision system is set up and controlled to monitor production area for the detection of contamination events. For example, computer vision system captures and processes data related to one or more individuals for the detection of contamination events, and also captures and processes data related to whether the individuals are wearing CCE and whether the CCE is properly positioned on the individual. Alternatively or additionally, computer vision system captures and processes data related to products and production equipment, and other items in the production area (e.g., utilities and other items) for a potential contamination event. For example, computer vision system can also be set up to capture and process data related leakage of a product container or of a pipe carrying fluid within the production area, breakage of a part of a production machine, entry of a foreign substance (e.g., dust, smoke or other airborne particulates) into the atmosphere of the production area from outside the production area.

Production area has multiple work zones therein. Although image data capturing devices (e.g., cameras) are shown outside of production area, they could be within production area. The one or more image data capturing devices could be within production area but not within any of work zones, or some or all image data capturing devices could be within one or more of work zones. Image data capturing devices provide image data input to one or more computer vision systems with data tracking and identifying personnel or body parts and actions thereof including location in production area, as well as whether an individual is within one of work zones. In addition to data provided by image data capturing devices, other data can be provided to computer vision system(s) via other data input means such as symbolic alpha, or numeric information embodied in or on a machine or machine-readable or human-readable identifier such as a tag or label (e.g., bar coded tag or label), a hole pattern, a radio frequency identification transponder (RFID) or other transmitting sensors, machine readable sensors, time stamps or biometric identification, CCE markers or designs or coloration, etc., as illustrated by other input data from production area as well as from items used in association with contamination events (e.g., napkins, tissues, etc).

The resulting automated process system provides data that is compared to predetermined fault criteria programmed into the one or more fault-detection analysis computers. For example, the fault criteria can be programmed to be met if an individual, present in the production area (and/or one or more of work zones), engages in a contamination event and is not wearing one or more properly-positioned articles of CCE required for the area and/or zone. If computer vision system in combination with fault-detection computer determines that the individual has engaged in a contamination event and that product, production equipment, or the production area are contaminated by the contamination event, data input from computer vision system to fault-detection computer can be programmed to cause fault-detection computer to trigger contamination control device. Contamination control device can take over one or more actions such as: (i) activating a contamination control means, (ii) activating an alarm, (iii) activating the generation and transmission of a report of a violation of contamination control protocol, (iv) activating a system to control, move, shield, sanitize, etc., a product or production article contaminated (or potentially contaminated) by a contamination event.

The automated monitoring and control process may utilize two or more computers. A first computer can serve to process the image data with respect to whether, for example, an individual is present, whether the individual engages in a contamination event, whether the individual is wearing an article of contamination control equipment, whether the contamination equipment is properly positioned on the individual. A second computer can process the data to conduct the fault-detection analysis and the resulting determination of whether to activate the contamination control device, based on the data from the first computer.

If the automated process is directed to the presence of a contamination event that is a potential germ-releasing event such as such as sneezing, coughing, vomiting, sweating, crying, bleeding, or spitting etc. (or any other contamination event), and proper germ-containment, for example, by use of a face mask, the machine vision system can be designed to view the scene and detect the face of an individual and perform segmentation based on proportionality to find the eyes, arms, legs, back, and waist of an individual and the corresponding movements attributable to a germ-releasing event. The machine vision system can be designed to find features associated with the germ-releasing event (including color mismatch when eyes are closed and arms are moved, etc.) and can be designed to remove non-moving objects, and zoom and/or read information on associated objects or persons and activate electromechanical circuit(s).

If the automated process is directed to the presence and proper use of a facemask (or any other form of germ-containment equipment for the body), the machine vision system can be designed to view the scene and perform background subtraction and detect the face of an individual, and perform segmentation based on proportionality to find the arms of the individual, and perform segmentation based on proportionality to find the hands of the individual. The machine vision system can be designed to find features associated with gloves, including color mismatch, etc. The machine vision system can be designed to find features associated with one or more gloves (including color mismatch, etc.) and can be designed to remove non-moving objects and zoom and/or read information on associated objects or individuals, and activate electromechanical circuit(s).

If the automated process is directed to the presence of an article that may be contaminated by the germ-releasing event (or any other contamination event), the machine vision system can be designed to view the scene and perform background subtraction, color detection, edge detection, and other techniques to characterize and match an object to a database of objects or to create a new database describing the object in order to fully track and activate electromechanical circuit(s) such as washing devices (i.e., on cutting boards), conveyor diverters, waste receptacles, wrapping machines, laser markers, inkjet markers etc.

The system may determine whether a one or more persons in a production area are involved in a contamination event. It may determine the presence or absence of CCE such as a face mask on the associated face, as well as whether the CCE is properly positioned on the face or body, and (iv) a fourth data processing module which utilizes a stabilization algorithm that tracks the face and body within the production area to ensure consistent data reporting.

Stabilization algorithm completes a data processing feedback loop to prevent “false positives” from occurring. In the absence of stabilization algorithm, it can be difficult to set up the image capturing device and associated primary data processing module and second processing module so that together they consistently maintain an accurate determination of the presence of a contamination event and/or absence of properly-positioned CCE on an individual in motion in the production area. The motion of the face and body, the motion of other objects in the production area, and various other factors have been found to make it difficult to consistently make accurate determinations of the presence and placement of a germ-releasing event or other contamination event in the production area.

As a result, inaccurate conclusions of non-compliance (i.e., “false positives”) have been found to occur at a high rate, particularly when image data is being captured at a rate of, for example, 50 images per second. Single occurrences of images which show the presence of a germ-releasing event characteristic such a droplet of liquid falling from the vicinity of a face but which are inaccurately assessed by the data processing to be in the absence of CCE, can soar to thousands per hour. For example, as applied to a germ-releasing event by an individual, the stabilization algorithm of fourth data processing module requires a combination of (a) assessment of a pre-determined quality of image (i.e., a minimum image value) associated with the face and body in the absence of a germ-releasing event and/or properly positioned CCE, and that this quality of image be present for at least a pre-determined minimum time period, before the system reports a germ-releasing contamination event and an associated CCE non-compliance event.

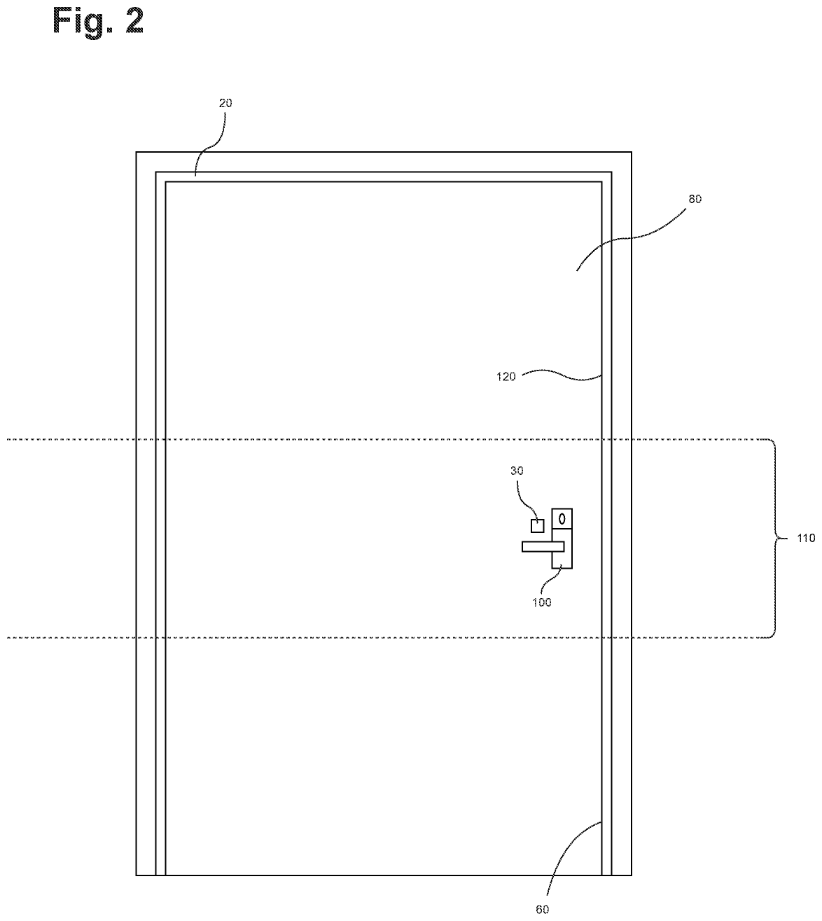

In this manner, the process can be carried out using a stabilization algorithm that reduces the occurrence of a false positive to, for example, less than 0.1a percent of all determinations of non-compliance determinations. In addition, the images can be processed so that an image having a very high image quality correlating with non-compliance can be saved as a record of the non-compliance event, e.g., for a report directed to a non-compliance event and/or a contamination event. Optionally, it can have the date, hour, and location provided therewith, together with other data such as the duration of the period of non-compliance, etc. The process loop of FIG. 2, and the use of a stabilization algorithm can also be applied to products in motion, production equipment in motion, and even stationary portions of the production environment.

Subsequently or in parallel an algorithm consisting of several modules assists in determining whether a germ-releasing event occurs, specifically: (a) a primary module that finds a moving object from a background within a work environment; (b) a secondary algorithm that finds an arm or other body part blob from the primary object; (c) a judgment algorithm that determines whether the blob has moved in relative position to other body parts or to the face in a time period or a manner characteristic of a germ-releasing event; and (d) an optional stabilization algorithm using tracking and time life to ensure accurate reporting.

This process can be used in combination with the process used to determine if a germ-releasing event has or is about to occur to activate an electromechanical circuit(s) or CC device. This is the portion of the process and system that are designed to provide a data feedback loop to prevent “false positives” from occurring. In short, the feedback loop of the stabilization algorithm is set up to determine, with a high degree of accuracy, whether the face actually is wearing a required article of CCE in a manner conforming to contamination protocol within the production area. Without the use of the stabilization algorithm, a multitude of false positives have been found to occur when using image capturing and processing of faces in motion in a production area. This same kind of algorithm can be used to determine whether a contamination event has occurred.

A visual low pass filter processing may assess whether the image value corresponds with the face properly wearing the required article of CCE, or not properly wearing the required article of CCE. A pre-determined image value threshold is used in processing the image of the tracked face. If the image of the tracked face is such that the assessed image value is less than the threshold image value, the image is assessed as either being unstable or that the required article of CCE is being properly worn by the face. In such an instance, no CC device is activated when a germ-releasing event occurs.

However, if the image value threshold is met during the low pass filter processing of the image of the tracked face, the processing is continued by assessing whether the time period over which the image value threshold is met is a time period that meets or exceeds a pre-determined threshold time period. If the image value threshold has not been met for the duration of the threshold time period, the result is that no CC device is activated. However, if the threshold image value is satisfied for the threshold time period, and a germ-releasing event has been determined to have occurred, a signal is sent that the face-associated CCE is “off” and that tracking is stable, with the result that a CC device is activated in addition to any object or food tracking that may occur to mitigate the effect of the germ-releasing event.

The system may detect sneezing using a computer algorithm further coupled to camera and computer hardware. The algorithm is carried out by obtaining an image of the face and detecting skin color in the image, followed by detecting motion of the image, followed by a labeling method, followed by finding an arm blob, followed by judging whether an arm has moved close to the face, whether the face can be characterized as sneezing, and whether the arm and hands have covered the face to detect a germ-releasing event.

### IV. Connected Equipment

A. Means of Connection

A communication module communicates between the tools or control panel and the technician. A communications module connects to or by the control panel or other controller of the protection system. The communications module wirelessly communicates with a service tool such as a personal data assistant. The technician may control the protection system with the service tool from a remote location such as by a monitoring device or other component being tested. The communications module may be taken with the technician when testing is complete or left in the building for later use. The communications module is provided as part of the protection system or is added at a later time to an existing system.

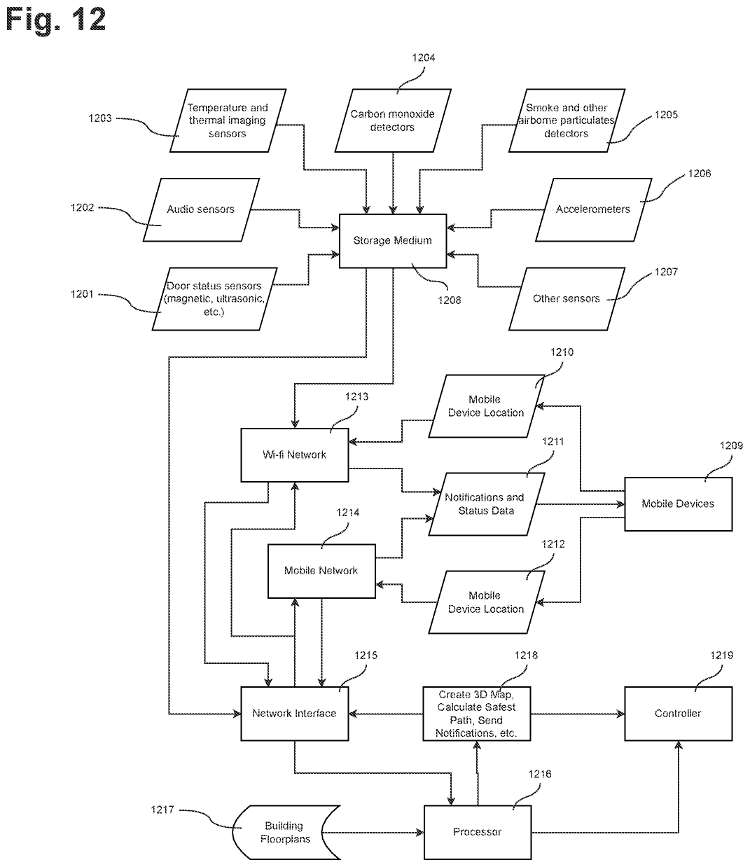

With reference to FIG. 12, the process begins by continuously collecting data from door status sensors 1201 that could be magnetic, ultrasonic, or any type, audio sensors 1202, temperature and thermal imaging sensors 1203, carbon monoxide detectors 1204, smoke and other airborne particulates sensors 1205, accelerometers 1206, or any other sensor relevant to emergency situation detection and monitoring 1207. The data is collected into storage medium 1208 and sent to the network interface 1215 through direct connection, or through an existing WiFi network 1213. Data can also be collected from mobile devices 1209, by sending information like device location 1210/1212 through a WiFi network 1213 or a cellular network 1214 to the network interface 1215. The processor 1216 may receive the data through the network interface and produce an analysis 1218 of the emergency situation.

The analysis may include but not be limited to recognizing an emergency situation, calculating a status of building integrity or compromise on a locational basis, creating a three-dimensional or two dimensional map of the emergency situation based on the locational status, calculating a safest path through the building to one or more emergency exits, sending notifications to at-risk mobile devices based on locational data, notifying first responders of the emergency situation, or calculating a safest path for emergency responders to take through the building to reach a desired destination. In order to be able to accurately analyze an emergency situation, the processor will be able to access the relevant building floor plans 1217. The results of the analysis, which can include notifications and status data 1211 can be sent back through the network interface 1215 to mobile devices 1209 connected to the networks 1213 or 1214, or they can be sent to controllers 1219 to mitigate the spread of fire, assist the mobile device users to address the emergency situation, or any other instructions relevant to the management of an emergency situation. The processor can also directly send instructions to the controllers without first analyzing the emergency situation.

Upon receiving a transmission from a sensor including information indicating the presence of the sense condition and information indicating that a test was conducted, e.g., the testing actuator is actuated when the predetermined condition is absent, the control panel does not communicate with the remote monitoring station. As such, a homeowner's test of the sensor by pressing a test button, for example, does not cause a false alarm to be reported to the remote monitoring station. Alternatively, upon receiving a transmission from a sensor including information indicating the presence of the sense condition but without information indicating that a test of the sensor was conducted (whether the transmission was caused by the presence of the sense condition or by the testing actuator being actuated with the predetermined condition present), the control panel communicates to the remote monitoring station information that the sense condition was sensed. The control panel may also provide information identifying the sensor that sensed the sense condition. As such, the predetermined condition is used by an installer, for example, to easily and efficiently cause a communication from the control panel to the remote monitoring station for purposes of fraud prevention measures.

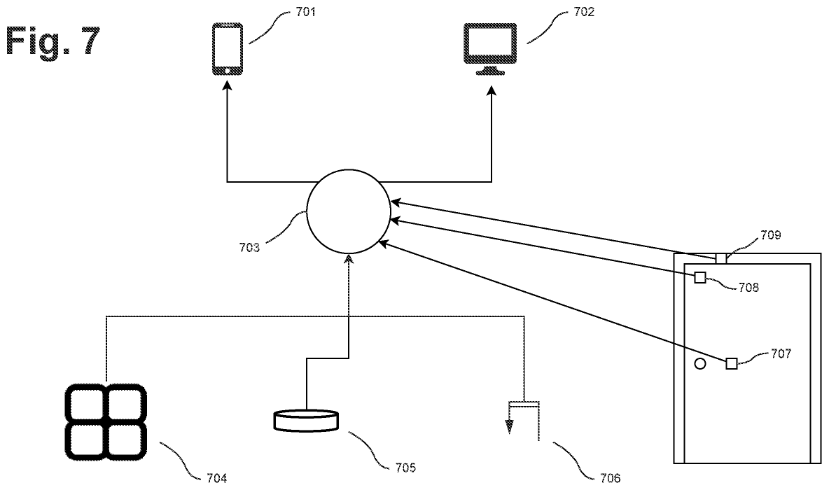

In FIG. 7, the window open/close sensor 704, fire sensor/alarm 705, sprinkler 706, door open/close sensors 709 708 and door handle open/close sensor 707 all connect to the network 703, which is then accessible via internet connection by desktop 702, mobile 701, or another means. This data can be accessed by landlords, regulatory authorities, fire fighters, emergency responders, and other individuals to conduct necessary maintenance and to track the location of a fire or other danger. A sensor may be used to check the gap between the door and the doorframe 708 709. The door handle sensor 707 checks that the door is present and has not been relocated. It also checks that the closer and lock are working, the door is not tampered with, and communicates the temperature on both sides of the door. It can also communicate whether or not there has been a shock to the door.

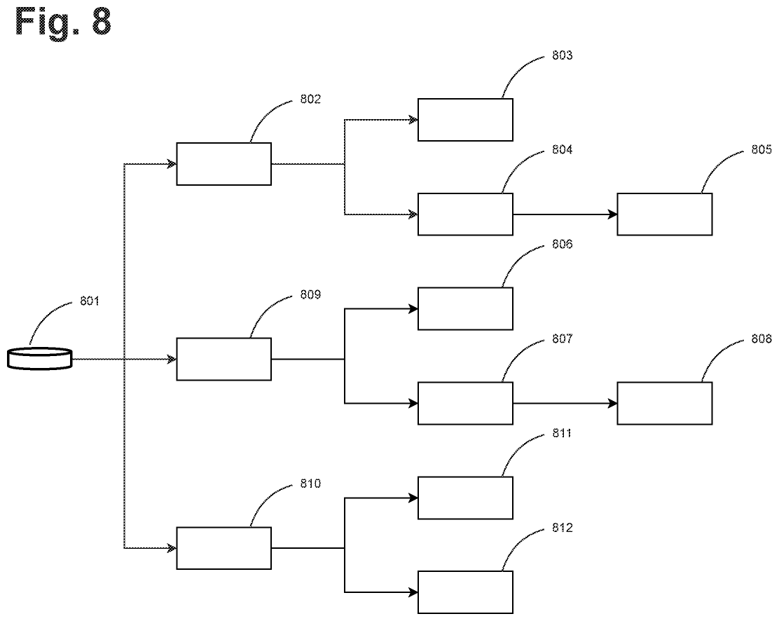

FIG. 8 is a flow chart representing how sensor information 801 may be interpreted by the program, resulting in action by the landlord or other responsible party. First, the program checks if there is a positive signal 810 (indicating a fire). If not, there is no alert sent 811. If there is, an alert is sent 810 and the appropriate authorities are notified and other safety features such as alarms may be activated. Next or simultaneously, the program may assess whether or not the sensor is present 802 based on information from the sensor 801. If present, no alert 803, if not present, then it will send an alert 804 to the responsible party, resulting in replacement 805 or other service according to regulatory and other requirements. Next or simultaneously, the program may assess whether or not the equipment's data (which can include device sensitivity and other parameters) meets regulatory requirements 809. If it does, there is no alert sent 806. If not, the responsible party is alerted 807 resulting in service or replacement 808.

Door and window status can be broadcast locally (to a local effector—such as a speaker/light), to an ad hoc network or communication channel (cellular (potentially to cell phones as well as a ‘main panel or monitoring station), RF, WiFi, Bluetooth, Zigbee, and others) or wired. The system has a means of communicating with a central or cloud-based computational aggregation facility that has the ability to survey for signals of data (or lack in change in signal) from fire safety elements as to their operational or functional status (opened, closed, vibration, movement, contact sensors, temperature, chemical senses, accelerometers, cameras or a wide range of other sensors.

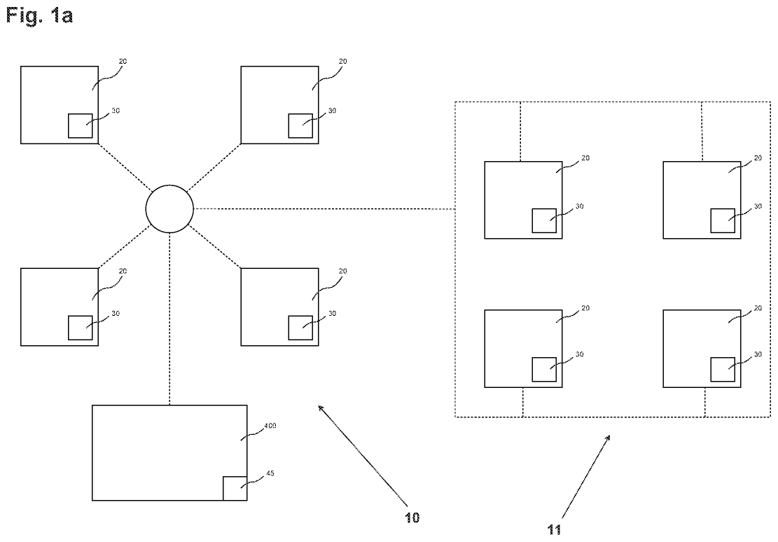

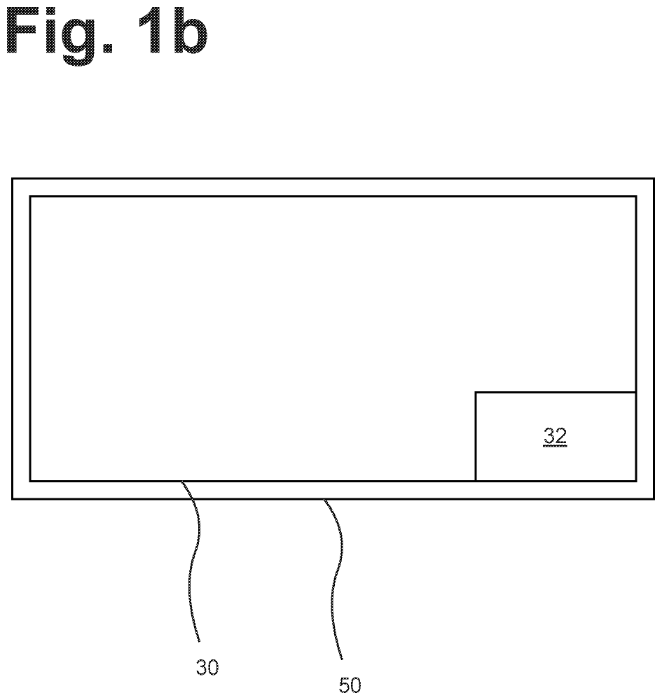

FIG. 1b is a schematic representation of an identifier used in the fire safety system of FIG. 1a, which can be embedded in the door or window and connected to the IOT system as a whole to report status.

### D. Fire Barriers

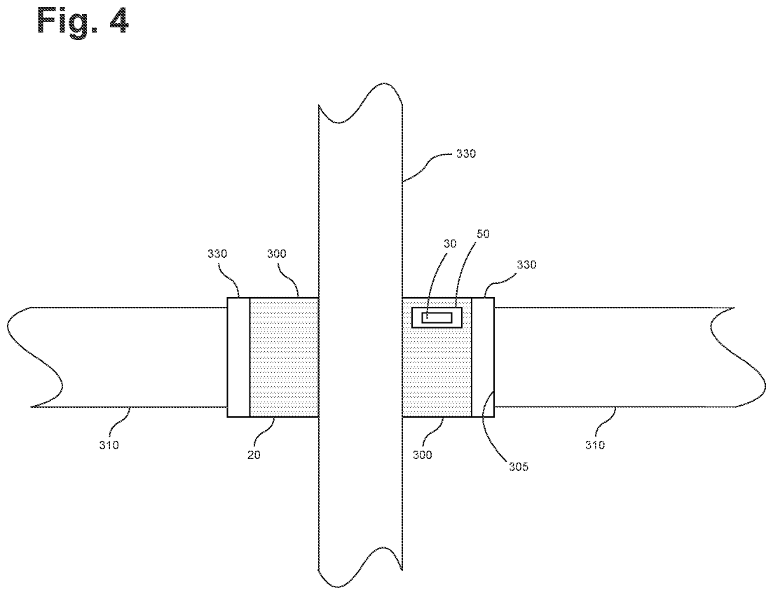

In an exemplary embodiment as shown in FIG. 4 the fire barrier 20 is configured to seal a gap. A major building component 310 such as a wall or floor of a building has an aperture 305 extending there though to enable a minor building component 320 such as a cable, pipe,duct, tray or riser arrangement to pass though the major building component 310. The aperture 305 is usually larger in diameter than the minor building component thereby leavinga gap between the minor building component 320 and the major building component 310. Such a gap may enable fire or smoke to spread between the various sections of the buildings which is undesirable hence a fire barrier 300 is provided to fill the gap. Depending on the situation the fire barrier 300 may comprise concrete, gypsum, graphite, rockwool, intumescent materials, specialist fire retardants or any other suitable material and may comprise multiple components. The fire barrier 300 may comprise multiple elements or layers and may for example comprise a sheath 330 made from a material such as metal or polythene. The fire barrier 300 is designed to stop or at least delay the progression of fireand/or smoke throughout the building. The fire barrier 300 may be provided with the identifier 30 and may again be protected by an intumescent arrangement 50. In one embodiment the identifier 30 is embedded in the material of the fire barrier 30.

Different fire barriers may include: fire door, fire rated window arrangement, a cavity barrier, a high-riser cabinet, an elevator shaft with fire barrier or another type of (partially) enclosed space or room with fire barrier properties.

Alternative arrangements of fire barriers 20 may be configured as a wrap, collar, mold or fire pillow and each may be provided with the identifier 30 (with or without an intumescent arrangement 50). The fire barrier 20 itself may (also) be provided with an intumescent arrangement 50 to protect the identifier 30.

Where desired the identifier 50 may not be attached directly to, or embedded in, the fire barrier 20. For example, where there is a space in the building such as a room, cabinet, cupboard, corridor or any other space where multiple fire barriers 20 are located in proximityto one another, their identifiers 30 may be grouped together (FIG. 1a section “A”) or even consolidated in fewer identifiers 30. A riser cupboard may for example comprise multiple risers in close proximity and their respective identifiers 50 may be grouped together on the wall or other suitable location for ease of attachment, finding, maintenance, service and/or interrogation.

There will be a hierarchical means of storing devices, doors/windows/rooms, fire barriers, floors, ‘zones,’ buildings. It may be possible to use this system as inventory management to know which items are deployed, when they are deployed, and what condition they are in. Possible sensor modalities include temperature, loud noise/audio, opening status—perhaps magnetic (fully open, slightly ajar), ultrasonic for door gap assessment and open/close status. The system can track changes in regulations and map these back into the components (also referred to here as connected equipment), and can also track recalls, firmware updates, and other information.

i. Doors

It may be advantageous to pose a solution in which fire doors are constantly being monitored through IOT to identify any damage. In this particular solution, there may be a fire safety system in which an identifier is associated with a fire barrier within a building. In many instances, this identifier may be a sensor located on or around a fire door. The identifier may further be configured to be interrogated by a communication device enabling data associated with the fire door to be recorded and/or examined.

In addition, in many embodiments, the sensor may verify that the door's lock is working. In many instances, a broken lock is evident of further damage to the door. In many instances wherein a lock has been broken, other areas such as the door's handle or framework may also be broken or damaged, which may negatively impact the strength and reliability of the fire barrier. In cases wherein a handle is broken, for example, the door may not adequately serve as an escape route during a fire emergency, which is one of the main purposes served by fire doors. A broken lock can also prevent the door from being fully closed, and as mentioned above, a fire door is useless if not fully closed.

In many embodiments, the sensor may also verify that the door has not been tampered with. Tampering with the door can, in many instances, cause damage, which may render the door useless. For example, tampering with the lock can prevent the door from being fully closed, which, as mentioned above, renders the door useless in a fire emergency, incapable of serving as a barrier to the spread of fire. Tampering with other parts of the door, such as the intumescent seal, may also cause damage. The intumescent seal is designed to expand to fit in the gaps of the door when exposed to high temperatures, blocking the space to prevent any flames from passing through. Thus, any ripping or otherwise breaking of the intumescent seal may prevent it from operating properly and may allow flames to pass through the barrier in a fire emergency.

This sensor may use laser or other technology. Additionally, the sensor may monitor the temperature on both sides of the door. In a fire emergency, the door's temperature will rise if flames are surrounding that side of the door. Thus, by monitoring the door's temperature, the sensor may identify any fires or flames on either side of the door. This may allow for the sensors to initially identify any fires and send signals to local fire or emergency departments, as well as alerting tenants or others in the building. More information on the system these sensors may operate with is included below.

The sensor may also sense the temperature of the door itself and/or its handle to assure it is safe for a human to open. Finally, the sensor may detect any shock towards the door. Shock towards the door may indicate that someone has been kicking, hitting, or otherwise physically damaging the door. It may also indicate that an object has applied strong force to the door. This force can be extremely damaging to the door and damage the door's strength, thus rendering it less capable to prevent the spread of fires. In some embodiments, a singular sensor on the fire door may perform all of these tasks. In other embodiments, multiple sensors may exist on the door such that each task is performed by a separate sensor or a combination of sensors.

In many embodiments, each of these sensors may communicate with a main system, following the basic structure of IOT. More details about such a main system will be included further below. In many embodiments, each sensor or group of sensors may be associated with a unique door ID. Such a unique ID may allow for the sensor to pass information towards a main system and accurately identify the location of the door. This may allow for the system to alert tenants or others in the buildings of any fires, and their precise locations, following the presence of high temperatures. Furthermore, this may allow for the system to alert fire departments or local emergency hotlines of fires and their precise locations. Additionally, this may allow for the system to alert building managers or others of any damage to the doors. This may, in turn, allow for repairs to be made in a timelier manner. In fire emergencies, or any emergency situation, time is the most important factor. The quicker a fire barrier can be repaired, the quicker it may go back to serving its purpose and preventing the spread of fire. With the aforementioned unique door ID associated with each sensor or group of sensors, any time spent searching for the damaged door among the fire barriers in the building is eliminated.

In an exemplary embodiment as shown in FIG. 2, the fire barrier 20 is a fire door 60. The firedoor 60 may be of any suitable construction and may be provided with one or more fire doorrelated products such as closers, hinges, door handles, door locks, signage, sealing strips, intumescent strips and windows. The fire door 60 may comprise a core 70 (not shown) with a fire-resistant material 80 on the outer surfaces, but the fire door 60 may be made from thefire-resistant material 80 throughout. The identifier 30 may be embedded in the fire door 60 such that at least a portion of the fire-resistant material 80 covers the identifier 30 to preventimmediate direct exposure of the identifier 30 to a fire. In an exemplary embodiment the fire door 60 is provided with a cavity 90 (not shown) configured to at least partially house a door control mechanism 100 such as a door handle, door lock or combined door handle and lock. The door control mechanism 100 may be located in a middle third section 110 of a long edge120 of the fire door 60 to such that it benefits from a more beneficial positioning along the thermal gradient that exists along the door in case of a fire. In an exemplary embodiment the identifier 30 is located in the fire door 60 proximal to the cavity 90, i.e., adjacent or in the cavity 90. The identifier 30 may be protected by the intumescent arrangement 50 (in this example shown as a capsule).

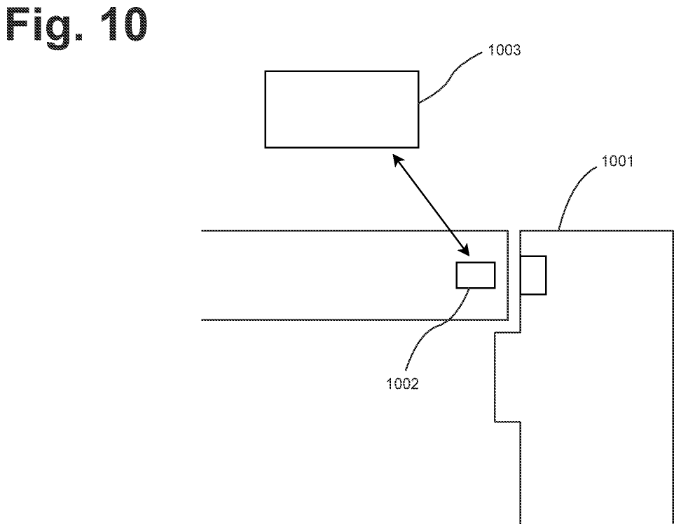

FIG. 10 is a diagrammatic representation of how a door sensor 708 in FIG. 7 may measure the distance between the door and the doorframe. It uses a small magnet set into the door frame 1001 and an AMR sensor 1002, and changes are measured and communicated to sensor module 1003.

In addition, in many embodiments, the sensor may verify that the door's lock is working. In many instances, a broken lock is evident of further damage to the door. In many instances wherein a lock has been broken, other areas such as the door's handle or framework may also be broken or damaged, which may negatively impact the strength and reliability of the fire barrier. In cases wherein a handle is broken, for example, the door may not adequately serve as an escape route during a fire emergency, which is one of the main purposes served by fire doors. A broken lock can also prevent the door from being fully closed, and as mentioned above, a fire door is useless if not fully closed.

In many embodiments, the sensor may also verify that the door has not been tampered with. Tampering with the door can, in many instances, cause damage, which may render the door useless. For example, tampering with the lock can prevent the door from being fully closed, which, as mentioned above, renders the door useless in a fire emergency, incapable of serving as a barrier to the spread of fire. Tampering with other parts of the door, such as the intumescent seal, may also cause damage. The intumescent seal is designed to expand to fit in the gaps of the door when exposed to high temperatures, blocking the space to prevent any flames from passing through. Thus, any ripping or otherwise breaking of the intumescent seal may prevent it from operating properly and may allow flames to pass through the barrier in a fire emergency.

This sensor may use laser or other technology. Additionally, the sensor may monitor the temperature on both sides of the door. In a fire emergency, the door's temperature will rise if flames are surrounding that side of the door. Thus, by monitoring the door's temperature, the sensor may identify any fires or flames on either side of the door. This may allow for the sensors to initially identify any fires and send signals to local fire or emergency departments, as well as alerting tenants or others in the building. More information on the system these sensors may operate with is included below.

The sensor may also sense the temperature of the door itself and/or its handle to assure it is safe for a human to open. Finally, the sensor may detect any shock towards the door. Shock towards the door may indicate that someone has been kicking, hitting, or otherwise physically damaging the door. It may also indicate that an object has applied strong force to the door. This force can be extremely damaging to the door and damage the door's strength, thus rendering it less capable to prevent the spread of fires. In some embodiments, a singular sensor on the fire door may perform all of these tasks. In other embodiments, multiple sensors may exist on the door such that each task is performed by a separate sensor or a combination of sensors.

In many embodiments, each of these sensors may communicate with a main system, following the basic structure of IOT. More details about such a main system will be included further below. In many embodiments, each sensor or group of sensors may be associated with a unique door ID. Such a unique ID may allow for the sensor to pass information towards a main system and accurately identify the location of the door. This may allow for the system to alert tenants or others in the buildings of any fires, and their precise locations, following the presence of high temperatures. Furthermore, this may allow for the system to alert fire departments or local emergency hotlines of fires and their precise locations. Additionally, this may allow for the system to alert building managers or others of any damage to the doors. This may, in turn, allow for repairs to be made in a timelier manner. In fire emergencies, or any emergency situation, time is the most important factor. The quicker a fire barrier can be repaired, the quicker it may go back to serving its purpose and preventing the spread of fire. With the aforementioned unique door ID associated with each sensor or group of sensors, any time spent searching for the damaged door among the fire barriers in the building is eliminated.

FIG. 1a shows a fire safety system 10 in accordance with the current disclosure. The fire safety system 10 may be used in any dwelling and is specifically suited for use in a commercial or multiple occupancy buildings, such as for example hospitals, schools, factories, offices, flats or tower blocks. The fire safety system 10 may include a variety of components and subsystems which will be discussed in further detail below.

The fire safety system 10 includes at least one fire barrier 20 provided with an identifier 30. The fire barrier 20 may for example be a fire door, a fire rated window arrangement, a cavitybarrier, a high-riser cabinet, an elevator shaft with fire barrier properties or another type of (partially) enclosed space or room with fire barrier properties.

The identifier 30 is a device capable of electronic communication with another device using wired or wireless technologies or a combination of both. The identifier 30 may for example include one or more suitable technologies such as RFID, RTLS, WIFI, Bluetooth or GSM and/or include components such as tags, microchips or other devices. The identifier 30 is preferably a passive component such that it does not require its own power source, but where suitable or preferred, identifier 30 may be a battery-assisted passive (BAP) component or an active component. In an embodiment of the identifier 30 being a BAP or a passive component, identifier 30 may collect energy from a communication device 40 sending interrogating radio waves.

The identifier 30 and/or a communications device 40 (discussed in more detail below) maybe provided with a locating arrangement 32 that enables a determination of where the identifier 30 is located. The locating arrangement 32 may for example comprise a GlobalPositioning System, a Local Positioning System, a Visual Positioning System, a Wi-Fi Positioning System, or any other suitable system or arrangement.

The identifier 30 may be fireproof, meaning it will at least resist fire for a period of time. The identifier 30 may for example be embedded in another component or assembly such that it is protected from fire. The identifier 30 may also be protected by an intumescent arrangement. The intumescent arrangement 50 may form a barrier, layer or capsule that activates incase of fire. The identifier 30 may be tamperproof meaning it will at least resist tampering for a period oftime. The identifier 30 may for example be embedded in another component or assembly such that it is protected from tampering. The identifier 30 may also be provided with atamper evidence arrangement.

The fire safety system may include a controller. The controller may include a pluralityof systems and sub-systems and may be located in any suitable place. In an exemplary embodiment the controller is located with data storage arrangement. In use, the fire safety system 10 may be used to manage fire barriers 20. Over time, fire barriers 20 may be moved, altered or tampered with, all possibly negatively affecting fire safety of buildings. For example, a fire door may be moved during refurbishments, a newaperture may be created in walls and floors to enable new cables to be installed, old pipework may be removed during an upgrade without backfilling the aperture, a fire door may be wedged open etc. The fire safety system 10 will enable an improved tracking,monitoring and management of the fire safety elements of a building.

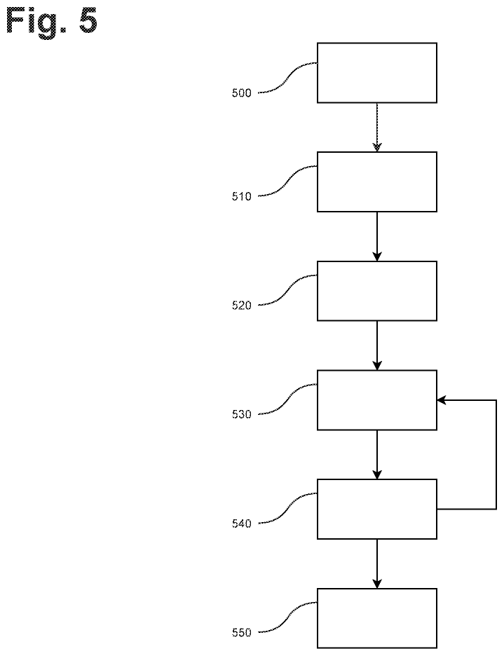

FIG. 5 sets out an exemplary method or operating a fire safety system 10. Step 500 is the production of a fire barrier 20 which may include attaching or embedding anidentifier 30 to or in the fire barrier 20. In Step 510 the fire rated safety component is installed in a building. If the identifier 30 was not installed during Step 500, it may be installed during Step 510. Step 520 comprises recording data associated with the fire ratedcomponent 20. The data recorded in Step 520 may also be associated with the building the fire rated component is installed in. Data recorded may include one or more of:
Dates—one or more of manufacture and installation;
Location—general or precise location of the fire rated safety component in a building;
History—how, when, why and by whom the fire barrier was installed.
The data may be stored in data storage arrangement 400. In Step 530, the identifier 30 may be interrogated during a post-installation or maintenanceinspection. The interrogation may take place using the communications device 40. Existing
data sets may then be updated and/or additional data may be recorded and stored in thedata storage arrangement 400.
Additional data recorded may include one or more of:
Dates—one or more of inspection, service, repair, detection of an event (e.g., tampering);
Location—general or precise location of the fire rated safety component in a building;
History—how, when, why and by whom the fire barrier was inspected, altered, serviced, modified and/or tampered with.

In Step 540 the data received from the interrogation process in Step 530 may be referenced against previously stored data by controller 45. If no anomalies are determined the process may loop back to Step 530. The loop back to Step 530 may be set at a suitable time interval.In one embodiment the time interval matches the next scheduled inspection interval.

The controller 45 is configured to trigger an appropriate course of action in Step 550 if an anomaly is detected. The appropriate course of action may be (a combination of) triggering an alarm, an entry in the data storage arrangement 400 and/or the triggering of an inspection. The appropriate action may also include a post-fire analysis.

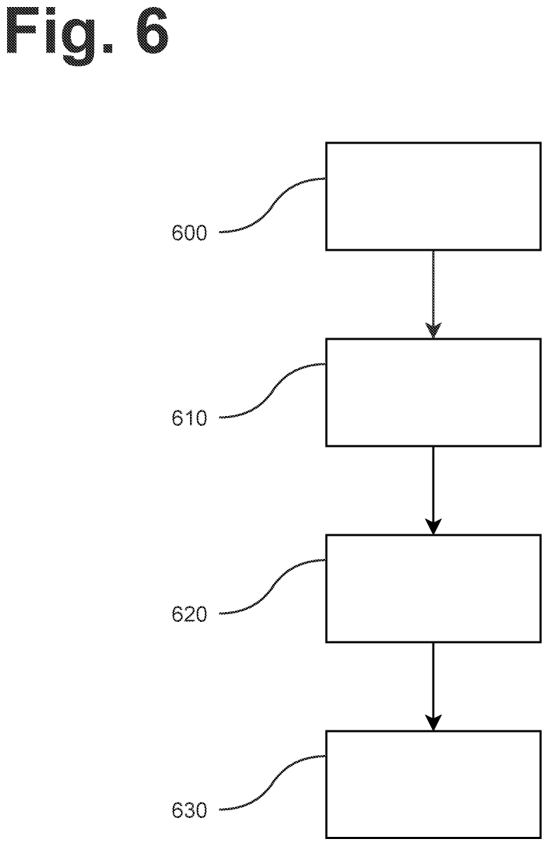

In an embodiment a hub 40b may (in parallel or series) interrogate multiple identifiers 30 (so-called bulk reading). When a fire breaks out the hub 40b may be able to detect which identifier 30 no longer responds properly to interrogation thereby indicating it may have been affected by the fire. This data may be transformed into a data set such as for example a mapindicating how the fire is spreading through a building. FIG. 6 shows an exemplary method ofsuch implementation.

In Step 600, the communication device 40 (the hub 40b being especially suited for this application) attempts to interrogate a plurality of identifiers 30 and communication anomaliesmay be detected.

An optional Step 610 enables the fire safety system to be placed in an “active fire mode”. Inthe active fire mode, the communication device 40 may interrogate the plurality of identifiers30 at shorter intervals or follow a different pattern of interrogation. The optional Step 610 may take place at any time including for example before Step 600 or any time after Step 620.

Any information regarding communication anomalies detected in Step 600 may be communicated to a user or the fire safety system 10 in Step 620. In an embodiment a graphic representation of the building, e.g., via a map, display or instrumentation panel, may be activated showing which identifiers 30 appear to be no longer communicating properly.

An appropriate course of action will be taken in Step 630 which may include triggering a fire extinguishing procedure such as providing guidance to a fire crew or activating fire suppressing system such as a sprinkler arrangement in the building. In an embodiment a sprinkler arrangement in only one or more section(s) of the building is activated.

ii. Windows

In the exemplary embodiments shown in FIGS. 3a-3f the fire barrier 20 comprises a window 130. The window 130 may be made of glass or any other suitable alternative such as plastic or Perspex. The window 130 may be fitted in a fire door 60 or it may be part of a windowassembly 140. Window 130 is fitted to a frame 150 (either in fire door 60 or in window assembly 140).

The identifier may be fitted onto the window 130, or off-window and adjacent to an edge ofthe window 130 as shown in FIGS. 3a-3f.

FIG. 3a shows an embodiment of the frame 150. The frame 150 has a base 160 and may have a first bead 170 and a second bead 175 forming a channel 180 for the window 130 to

be positioned in. The first and second beads 170, 175 may be any suitable shape and size and at least one of them may comprise a fire resistant or intumescent material. The base 160may be provided with a recess 190 and the identifier 30 may be at least partially located in the recess 190.The identifier 30 may be positioned adjacent to an edge of the window 130, i.e., it may be positioned on an edge of the window 130 itself, or off the window 130 but adjacent to it. If the identifier 30 is located off the window 130, it may be located in a positionoffset to the window 130, but the identifier 30 is preferably not exposed externally, i.e., it is embedded in the frame 150 or covered by at least one off the first and second beads 170, 175.

FIG. 3b shows a similar arrangement to FIG. 3a, but further comprises a U-shaped element 200 forming the channel 180 for the window 130 to be positioned in. The U-shaped element 200 may comprise a fire resistant or intumescent material. In this embodiment the identifier 30 is separated from the window 130 by a portion of the U-shaped element 200. The first and second beads 170, 175 may be omitted.

FIG. 3c is a variation of the embodiment of FIG. 3b with the identifier 30 offset to the window 130. In an alternative arrangement the U-shaped element 200 and/or the first and secondbeads 170, 175 may be omitted. The identifier 30 is preferably not exposed externally.

FIG. 3d shows a further variant wherein the base 160 is provided with a recess 190 and theU-shaped element 200 is provided with a recess 210. A first portion of the identifier 30 is positioned in recess 190 and second portion of the identifier 30 is positioned in recess 210. The identifier 30 may be offset to the window 130. The first and second beads 170, 175 maybe omitted. The identifier 30 is preferably not exposed externally.

FIG. 3e shows a further variant wherein the U-shaped element 200 is provided with a recess210 and the identifier 30 is positioned in recess 210. The identifier 30 may be offset to the window 130. The first and second beads 170, 175 may be omitted. The identifier 30 is preferably not exposed externally.

FIG. 3f shows a further variant wherein the U-shaped element 200 is provided with a recess210 at the bottom of the channel 180 and the identifier 30 is positioned in recess 210 and may be in direct contact with the window 130. The identifier 30 may be offset to the window 130. The first and second beads 170, 175 may be omitted. The identifier 30 is preferably not exposed externally.

In any of the embodiments shown in FIGS. 3a-3f, the identifier 30 may be protected byintumescent material 50.

### E. Other Equipment

Multisensor/multicriteria detection technology, making use of various alarm and diagnostic criteria from a combination of input signals from sensors responding to different fire phenomenon, e.g., signals from a photoelectric smoke sensor and a temperature sensor were combined using modern techniques of signal analysis, such as neural networks and fuzzy logic, which by far exceed commonly used simple logic. The storage of information will include off-premise storage (in the case of fire or other incident) and/or cloud-based storage.

Fire sensors and equipment may include:
Sensors for Heat, Smoke, Carbon Monoxide and Fire Detection
System can make use of different fire detection sensors
Light/photoelectronic
Particle sensors (using light and collimators)
Carbon Monoxide detectors
Ionization chamber smoke detectors (ICSD)
Heat detectors
Thermal imaging cameras
Magnetic switches—opening status—perhaps magnetic (fully open, slightly ajar)
Accelerometers
Radio detection for detecting cell phones
Making use of cell phone sensors of occupants to help detect or provide additional data during a fire/smoke incident through the use of an App or other software to provide data input
Temperature
Loud noise/audio
Ultrasonic for door gap assessment and open/close status
Other components

And Fire safety elements may include local alarms or actuators with singular or combination of:
Production of light (flashing or constant)
Sound (different sounds—constant or patterns)
Sending signals to enable centralized alarms to activate
Actuators to close a door, blind, or other action intended to suppress or prevent the spread of a fire or smoke
Provide fire announcement through mobile devices (through a combination or singular use of cell phone app, text messages, phone calls or other notifications)
The invention may incorporate future sensor technologies (such as LIDAR—laser imaging would help see through smoke), and ‘robots’ that are like the robot vacuums (or drones) that inspect spaces should there be a fire for signs of life in each space with LIDAR and IR (to see thermal signatures of people/pets).

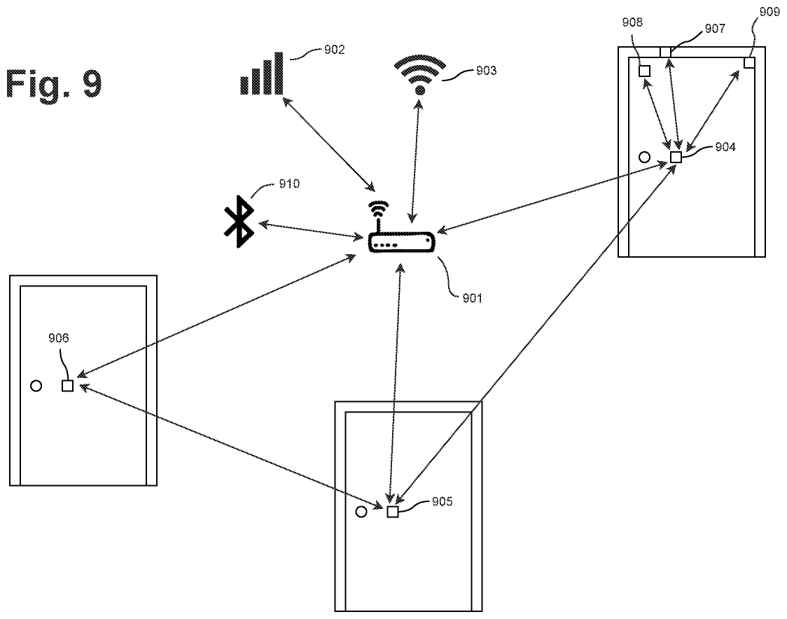

FIG. 9 is a schematic representation of network topology. Sensors 906 905 904 907 908 connect to a wireless repeater 901 via Bluetooth 910 and/or other means. Sensors, such as door handle open/close sensors, may also connect to each other as part of the IOT. The use of the wireless repeater connects up ‘dead spots,’ enables single points of access, and connects to other facilities such as alarm systems. A sub lg wireless network may be used to connect sensors to other sensors. The repeater may connect to a the BMS via Optional LTE connection 902 and/or optional wireless connection/ethernet 903.

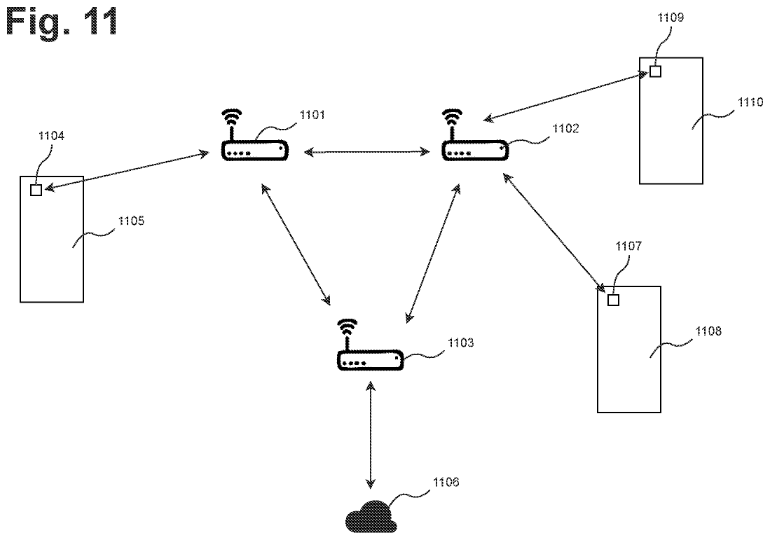

FIG. 11 is a schematic representation of network topology. Door 1105 1108 1109 sensors 1104 1107 1109 and/or other sensors connect to wireless repeaters 1101 1102 1103, connected to power or battery and each other via Bluetooth or another means. They may also be connected to the cloud 1106.

There are specific design guidelines and perhaps a ‘certification program’ that would be very useful to insure proper installation and data inputs (using standard means) to insure that the fire brigade, owners and others would be able to interpret the installation information as well as emergent information when needed. Furthermore, such certification would insure proper functional installation to provide optimal safety, as well as maintenance. It was noted that the availability of such as system would enable up-skilling carpenters (with higher fees) for installation of ‘smart sensors’ and the systems. There may be some government or non-profit support for economic relief and provision of re-tooling the professions to enable career growth for individuals who learn to install and maintain such systems.

Fire safety elements can communicate through a variety of different communication protocols. Status can be broadcast locally (to a local effector—such as a speaker/light), to an ad hoc network or communication channel (cellular (potentially to cell phones as well as a ‘main panel or monitoring station) and/or using technologies such as RF, Wi-Fi, Bluetooth, Zigbee, RFID, RTLS, GSM, and others) or wired connections by themselves or in combination.

Fire safety elements may be provided with power from a combination or singular sources including: battery, solar, line-power, regenerative from mechanical-electronic sources (e.g., piezo electric), interrogating radio-waves, wireless charging (inductive charging) or other sources of energy.

Fire safety elements may also be equipped with positioning devices using a singular or in-combination technology which makes use of global positioning, local positioning, a Wi-Fi positioning system, a visual positioning system, or another suitable system or arrangement.

Fire safety elements may be fireproof, meaning it will resist fire for a period of time. This may involve an intumescent arrangement. They may also be considered tamperproof—such that they can resist tampering for a period of time (or embedded in another component) such that they can resist tampering for a period of time.

In one embodiment, a control panel may be provided for a security system for a premises, as well as a method of operating such a control panel. The control panel uses a special mode of operation to prompt a communication to a remote monitoring station when that otherwise would not occur. If the control panel is operating in a first mode (for example, a normal operating mode where the security system is “disarmed”), upon the control panel receiving a sensor transmission including information indicating both the presence of the sense condition and that a test was conducted, the control panel does not send a communication to the remote monitoring station. If, however, the control panel is operating in a second mode (for example, an installation mode), upon receiving the same such transmission, the control panel sends a communication to the remote monitoring station indicating the presence of the sense condition at the premises, and perhaps information identifying the sensor that provided the transmission to the control panel.

This installation mode of operation for the control panel may be used to provide a communication to the remote monitoring station when such a communication is needed, again for example during installation as a fraud prevention measure. In addition, this capability is provided without the need for sensors that utilize the predetermined condition or an additional testing actuator to provide a transmission that appears to be an alarm transmission when it actually is not.

In a further embodiment, the control panel has a special mode of operation to prompt a communication to a remote monitoring station when that otherwise would not occur. In the first mode as with the previously discussed embodiment, upon receiving a transmission from a sensor including information of the presence of the sense condition and that a test of the sensor was actuated, the control panel does not send a communication to the remote monitoring station. If, however, the control panel is operating in a second mode (for example, a verification mode as part of the installation process), upon receiving the same such transmission, the control panel communicates sensor identifying information to the remote monitoring station for the sensors that provided transmissions to the control panel. Again, this may be done, for example, to verify that the sensors have been installed at the premises.

In either of the embodiments of a control panel with a special mode to provide a communication to the remote monitoring station when that otherwise would not occur, the control panel may receive a transmission from a sensor indicating the presence of a sense condition but that a test of the sensor has not been conducted. Such would be the case, for example, when the sense condition is actually present and an alarm needs to be reported. If this happens, and if the operating mode for the control panel is one where alarm conditions are normally reported to the remote monitoring station (for example, in a normal operating mode), a communication to the remote monitoring station will be made indicating the presence of the sense condition at the premises, and possibly providing information identifying the sensor.

The sensor described above may be any variety of sensors, such as a smoke detector, door/window sensor, etc. Also, the method and systems applies to wireless security systems where sensors communicate with the control panel by radio frequency (RF) transmissions, and also to hard-wired security systems where sensors are hard-wired to the control panel and where the transmissions from sensor to control panel are provided over that hard-wired connection.

A security system may be used to monitor various security conditions in a premises such as a home or business. Security system includes a control panel and a variety of sensors including a smoke detector. In one embodiment, sensors can use a wired communication path to transmit to control panel the security condition information including alarm and test signals. In a similar manner, smoke detector transmits security condition information to control panel over a wireless communications path. Control panel monitors sensors and smoke detector for receipt of the security condition information and determines whether to report such information to an off-premises, remote monitoring station (not shown). Control panel contains a visual display that displays the security conditions to a user.

Smoke detectors may include a sensor control application (e.g., a circuit or a software routine) that manages a tamper switch associated with a tamper monitoring application (e.g., a circuit or a software routine), a test button associated with a test button application (e.g., a circuit or a software routine), a smoke sensing application (e.g., a circuit or a software routine), a power supply, a power supply condition detection application (e.g., a circuit or a software routine), a communication application (e.g., a circuit or a software routine), and an audible siren. Tamper monitoring application detects the presence of tampering and provides a tamper signal indicating such presence to sensor control application. For example, tamper monitoring application in conjunction with tamper switch detects whether tampering has occurred with smoke detector. Tamper switch, as is conventional, may be in a closed state when the encasement of detector is closed, but then opens when the encasement is opened. Alternatively, tamper switch is closed when detector is in its installed mounted state, and open when detector is removed from such a state.

In another embodiment, a control panel is provided for a security system for a premises, as well as a method of operating such a control panel. The control panel uses a special mode of operation to prompt a communication to a remote monitoring station when that otherwise would not occur. If the control panel is operating in a first mode (for example, a normal operating mode where the security system is “disarmed”), upon the control panel receiving a sensor transmission including information indicating both the presence of the sense condition and that a test was conducted, the control panel does not send a communication to the remote monitoring station. If, however, the control panel is operating in a second mode (for example, an installation mode), upon receiving the same such transmission, the control panel sends a communication to the remote monitoring station indicating the presence of the sense condition at the premises, and perhaps information identifying the sensor that provided the transmission to the control panel.

This installation mode of operation for the control panel may be used to provide a communication to the remote monitoring station when such a communication is needed, again for example during installation as a fraud prevention measure. In addition, this capability is provided without the need for sensors that utilize the predetermined condition or an additional testing actuator to provide a transmission that appears to be an alarm transmission when it actually is not.

In a further embodiment, the control panel has a special mode of operation to prompt a communication to a remote monitoring station when that otherwise would not occur. In the first mode as with the previously discussed embodiment, upon receiving a transmission from a sensor including information of the presence of the sense condition and that a test of the sensor was actuated, the control panel does not send a communication to the remote monitoring station. If, however, the control panel is operating in a second mode (for example, a verification mode as part of the installation process), upon receiving the same such transmission, the control panel communicates sensor identifying information to the remote monitoring station for the sensors that provided transmissions to the control panel. Again, this may be done, for example, to verify that the sensors have been installed at the premises.

In either of the embodiments of a control panel with a special mode to provide a communication to the remote monitoring station when that otherwise would not occur, the control panel may receive a transmission from a sensor indicating the presence of a sense condition but that a test of the sensor has not been conducted. Such would be the case, for example, when the sense condition is actually present and an alarm needs to be reported. If this happens, and if the operating mode for the control panel is one where alarm conditions are normally reported to the remote monitoring station (for example, in a normal operating mode), a communication to the remote monitoring station will be made indicating the presence of the sense condition at the premises, and possibly providing information identifying the sensor.

The sensor described above may be any variety of sensors, such as a smoke detector, door/window sensor, etc. Also, the method and systems applies to wireless security systems where sensors communicate with the control panel by radio frequency (RF) transmissions, and also to hard-wired security systems where sensors are hard-wired to the control panel and where the transmissions from sensor to control panel are provided over that hard-wired connection.

System may connect to the security system on premises such as a home or business. Security system may include a control panel and a variety of sensors including a smoke detector. In one embodiment, sensors can use a wired communication path to transmit to control panel the security condition information including alarm and test signals. In a similar manner, smoke detector transmits security condition information to control panel over a wireless communications path. Control panel monitors sensors and smoke detector for receipt of the security condition information and determines whether to report such information to an off-premises, remote monitoring station (not shown). Control panel contains a visual display that displays the security conditions to a user.

Smoke detector may include a sensor control application (e.g., a circuit or a software routine) that manages a tamper switch associated with a tamper monitoring application (e.g., a circuit or a software routine), a test button associated with a test button application (e.g., a circuit or a software routine), a smoke sensing application (e.g., a circuit or a software routine), a power supply, a power supply condition detection application (e.g., a circuit or a software routine), a communication application (e.g., a circuit or a software routine), and an audible siren. Tamper monitoring application detects the presence of tampering and provides a tamper signal indicating such presence to sensor control application. For example, tamper monitoring application in conjunction with tamper switch detects whether tampering has occurred with smoke detector. Tamper switch, as is conventional, may be in a closed state when the encasement of detector is closed, but then opens when the encasement is opened. Alternatively, tamper switch is closed when detector is in its installed mounted state, and open when detector is removed from such a state.

Test button application detects the activation of the test button and provides a test signal to sensor control application and also provides a gain signal to smoke sensing application for reasons that are described later. Sensor control application can use the test signal to determine whether test button is in an open or depressed state, and may also measure the length of time that button has been depressed.

In one embodiment, smoke sensing application is a circuit including circuitry to detect the presence of smoke and/or a heat condition associated with a fire and to generate an alarm signal indicating the presence of such a condition to sensor control application. As is conventional, the presence of smoke obscuration or heat alters the level of an electrical signal in smoke sensing application that is compared to a threshold level to determine if the sensed condition is present. When the electrical comparison is met or exceeded, smoke sensing application produces an alarm signal. When test button is pressed, the gain signal thus provided to the smoke sensing application changes the electrical comparison condition, and causes smoke sensing application to produce the alarm condition output even when the sensed condition is not present, if the sensor is working properly—that is, smoke sensing application is in working order and the charge on power supply is sufficient.

Power supply, such as an internal battery or an external alternating current (AC) power source, provides power to the smoke detector. Power supply condition detection application monitors the condition of power supply and provides a signal to sensor control application. The signal may be, for example, an indication of the level of charge on the battery, from which sensor control application may determine, for example, the present power capacity of the battery, whether a new battery has been recently installed, and whether it is time to replace the battery. Audible siren may sound locally when a condition exists, and may “chirp,” for example, when a low-battery condition is present. Although not shown, the sensor may also include a light indicator to provide the user with a visual indication of the status of the sensor.

In one embodiment, sensor control application is a circuit and includes internal circuitry (not shown) that processes signals it receives and generates appropriate responses. A communication application is connected to sensor control application and sends transmissions that are to be received by control panel. An exemplary communication application is a radio frequency (RF) transmitter capable of communicating wirelessly As discussed below, sensor control application can be configured to process various types of smoke detector tests. The details of implementing sensor control application and communication application are within the scope of a person skilled in the art, and therefore are not described herein.

Smoke detector may include an installation button and an associated installation button application. In one embodiment, installation button application detects activation of installation button and provides a test signal to sensor control application, as well as a gain signal to smoke sensing application similar to that provided by test button application In an alternative embodiment, installation button application does not provide a gain signal (GAIN) to smoke sensing application. Sensor control application uses the test signal to determine whether installation button is in an open or depressed state. In addition, if button is depressed, application may also measure the length of time that button has been in the depressed state.

Installation button, in one implementation, is located within a housing of detector. The housing includes an opening therethrough for access to installation button. Opening in the sensor housing is sized such that elongated tools substantially similar in size to the diameter of an extended paper clip may be extended through opening. Opening in the sensor housing is aligned with installation button inside the housing so that extending an elongated tool, such as an extended paper clip for example, through opening may be done to actuate the installation button. With such a design, a homeowner would be unlikely to actuate installation button, and may not even know it exists.

Owners may choose to test the system and connected equipment. As an example, the first type of test may be one designed for a homeowner to conduct, for example, to periodically check to ensure the sensor is working properly. If sensor control application determines that the signals it receives indicate that the first type of test has been conducted, then sensor control application, in connection with communication application, generates a transmission that includes information indicating the presence of a sense condition sensed by the sensing device (for example, smoke sensing application) and information indicating that a test was conducted.

Alternatively, if the type of test conducted upon sensor is not of the first type, sensor control application determines whether the signals it is receiving indicate that a second type of test has been conducted. As an example, the second type of test may be one an installer conducts when installing the sensor in the security system. If sensor control application 30 determines that the signals indicate the second type of test has occurred, then sensor control application, in conjunction with communication application, generates a transmission that includes information indicating the presence of the sensed condition but not information indicating that a test of the sensor was conducted. Once sensor control application determines the type of test conducted, control application continues monitoring its inputs.

Building may include connected equipment, which can include any type of equipment used to monitor and/or control building. Connected equipment can include connected chillers, connected AHUs, connected actuators, connected controllers, or any other type of equipment in a building HVAC system (e.g., boilers, economizers, valves, dampers, cooling towers, fans, pumps, etc.) or building management system (e.g., lighting equipment, security equipment, refrigeration equipment, etc.). Connected equipment can include any of the equipment of HVAC system, waterside system, airside system.

Connected equipment can be outfitted with sensors to monitor particular conditions of the connected equipment. For example, chillers can include sensors configured to monitor chiller variables such as chilled water return temperature, chilled water supply temperature, chilled water flow status (e.g., mass flow rate, volume flow rate, etc.), condensing water return temperature, condensing water supply temperature, motor amperage (e.g., of a compressor, etc.), variable speed drive (VSD) output frequency, and refrigerant properties (e.g., refrigerant pressure, refrigerant temperature, condenser pressure, evaporator pressure, etc.) at various locations in the refrigeration circuit. Similarly, AHUs can be outfitted with sensors to monitor AHU variables such as supply air temperature and humidity, outside air temperature and humidity, return air temperature and humidity, chilled fluid temperature, heated fluid temperature, damper position, etc. In general, connected equipment monitor and report variables that characterize the performance of the connected equipment. Each monitored variable can be forwarded to network control engine as a data point (e.g., including a point ID, a point value, etc.).

Monitored variables can include any measured or calculated values indicating the performance of connected equipment and/or the components thereof. For example, monitored variables can include one or more measured or calculated temperatures (e.g., refrigerant temperatures, cold water supply temperatures, hot water supply temperatures, supply air temperatures, zone temperatures, etc.), pressures (e.g., evaporator pressure, condenser pressure, supply air pressure, etc.), flow rates (e.g., cold water flow rates, hot water flow rates, refrigerant flow rates, supply air flow rates, etc.), valve positions, resource consumptions (e.g., power consumption, water consumption, electricity consumption, etc.), control setpoints, model parameters (e.g., regression model coefficients, etc.), and/or any other time-series values that provide information about how the corresponding system, device, and/or process is performing. Monitored variables can be received from connected equipment and/or from various components thereof. For example, monitored variables can be received from one or more controllers (e.g., BMS controllers, subsystem controllers, HVAC controllers, subplant controllers, AHU controllers, device controllers, etc.), BMS devices (e.g., chillers, cooling towers, pumps, heating elements, etc.), and/or collections of BMS devices.

Connected equipment can also report equipment status information. Equipment status information can include, for example, the operational status of the equipment, an operating mode (e.g., low load, medium load, high load, etc.), an indication of whether the equipment is running under normal or abnormal conditions, a safety fault code, and/or any other information that indicates the current status of connected equipment. In some embodiments, each device of connected equipment includes a control panel. The control panel can use the sensor data to shut down the device if the control panel determines that the device is operating under unsafe conditions. For example, the control panel can compare the sensor data (or a value derived from the sensor data) to predetermined thresholds. If the sensor data or calculated value crosses a safety threshold, the control panel can shut down the device and/or operate the device at a derated setpoint. The control panel can generate a data point when a safety shut down or a derate occurs. The data point can include a safety fault code which indicates the reason or condition that triggered the shut down or derate.

Connected equipment can provide monitored variables and equipment status information to a network control engine. Network control engine can include a building controller a system manager, a network automation engine, or any other system or device of building configured to communicate with connected equipment. In some embodiments, the monitored variables and the equipment status information are provided to network control engine as data points. Each data point can include a point ID and/or a point value. The point ID can identify the type of data point and/or a variable measured by the data point (e.g., condenser pressure, refrigerant temperature, fault code, etc.). Network control engine can broadcast the monitored variables and the equipment status information to a remote operations center (ROC). ROC can provide remote monitoring services and can send an alert to building in the event of a critical alarm. ROC can push the monitored variables and equipment status information to a reporting database, where the data is stored for reporting and analysis.

### F. Status Reports and Compliance

The system may track changes in regulatory and map back into components. One regulatory example is in the United States—NFPA 72 2016, National Fire Alarm and Signaling Code. For example, the code already allows a /re alarm system to be installed on an ethernet network using Class N cabling techniques. NFPA 72, Section 3.3.67, defines a Class N device as “A supervised component of a life safety system that communicates with other components of life safety systems and that collects environmental data or performs specific input or output functions necessary to the operation of the life safety system.” Typically, Class N devices include components connected to a Class N ethernet network that monitors inputs from the environment—such as smoke or heat—and provides outputs that address all the other life safety equipment.

System tracks ‘recalls, firmware updates’ and the respective status of each and other information. Tracking of occupant reports regarding devices/tags and information about potential difficulties, and the system may also track recalls or other key information about fire safety components. It may have service record recording and tracking (e.g., service provider name, date, extent of service, statement of work associated with maintenance or replacement of components), and also track the serial number, part number, and other information about fire-related devices as well as dates of deployment and track their condition.

The system may use a hierarchical/taxonomy method of storing devices, associated tags, doors/windows/rooms, fire barriers, floors, ‘zones,’ and buildings and provide for a preventive maintenance schedule for devices. The system may use a data base for parts replacement alerts and automated design of maintenance schedules (e.g., smoke detector life cycle timing, LED lighting life for exit doors, other sensor life cycle information).

The inventory can provide a listing the functional requirement for different sensors/actuators for the building, existing products (or replacement products when products are no longer available) that could fulfill these requirements, what is missing from existing products, some functional requirements such as temperature operational range, etc.

The inventory system could include an ‘approved installer and maintenance’ list of companies/individuals. In another implementation, instead of, or in addition to, using the predetermined condition as described previously, the sensor may be provided with an additional, second testing actuator. As with the previously discussed embodiment, in response to the first testing actuator being actuated, the sensor generates a transmission including information indicating the presence of the sense condition and information indicating that a test of the sensor was conducted. In response to actuation of the second testing actuator, however, the sensor generates a transmission including information indicating the presence of the sense condition but not information indicating that a test of the sensor has been conducted.

In this dual testing actuator implementation, the first testing actuator may be a test button provided on an external housing of the sensor and easily accessible by a homeowner, as is typical with smoke detectors, for example. The second testing actuator, however, is preferably not easily accessible to reduce the possibility of accidental actuation by the homeowner and/or the installer. In one implementation, the second testing actuator is inside the sensor's housing, and the housing has a small hole through which a triggering tool, e.g., an extended paper clip, may be extended to actuate the testing actuator within.

The control panel, upon receiving a transmission from a sensor including information indicating the presence of the sense condition and information indicating that a test was conducted, e.g., when the first of the two testing actuators has been actuated, the control panel does not communicate with the remote monitoring station. Upon receiving a transmission from a sensor including information indicating the presence of the sense condition but without information indicating that a test of the sensor was conducted (whether the transmission was caused by the presence of the sense condition or by the second testing actuator being actuated), the control panel communicates to the remote monitoring station information that the sense condition was sensed, and also may provide information identifying the sensor that sensed the sense condition.

Test button application detects the activation of the test button and provides a test signal to sensor control application and also provides a gain signal to smoke sensing application for reasons that are described later. Sensor control application can use the test signal to determine whether test button is in an open or depressed state, and may also measure the length of time that button has been depressed.

In one embodiment, smoke sensing application is a circuit including circuitry to detect the presence of smoke and/or a heat condition associated with a fire and to generate an alarm signal indicating the presence of such a condition to sensor control application. As is conventional, the presence of smoke obscuration or heat alters the level of an electrical signal in smoke sensing application that is compared to a threshold level to determine if the sensed condition is present. When the electrical comparison is met or exceeded, smoke sensing application produces an alarm signal (ALARM). When test button is pressed, the gain signal (GAIN) thus provided to the smoke sensing application changes the electrical comparison condition, and causes smoke sensing application to produce the alarm condition (ALARM) output even when the sensed condition is not present, if the sensor is working properly—that is, smoke sensing application is in working order and the charge on power supply is sufficient.

Power supply, such as an internal battery or an external alternating current (AC) power source, provides power to the smoke detector. Power supply condition detection application monitors the condition of power supply and provides a signal to sensor control application. The signal may be, for example, an indication of the level of charge on the battery, from which sensor control application may determine, for example, the present power capacity of the battery, whether a new battery has been recently installed, and whether it is time to replace the battery. Audible siren may sound locally when an ALARM condition exists, and may “chirp,” for example, when a low-battery condition is present. Although not shown, the sensor may also include a light indicator to provide the user with a visual indication of the status of the sensor.

In one embodiment, sensor control application is a circuit and includes internal circuitry (not shown) that processes signals it receives (for example, ALARM, TEST, and TAMPER) and generates appropriate responses. A communication application 46 is connected to sensor control application and sends transmissions that are to be received by control panel. An exemplary communication application is a radio frequency (RF) transmitter capable of communicating wirelessly As discussed below, sensor control application can be configured to process various types of smoke detector tests. The details of implementing sensor control application and communication application are within the scope of a person skilled in the art, and therefore are not described herein.

The smoke detector may have an installation button located within a housing of detector. The housing includes an opening therethrough for access to installation button. Opening in the sensor housing is sized such that elongated tools substantially similar in size to the diameter of an extended paper clip may be extended through opening. Opening in the sensor housing is aligned with installation button inside the housing so that extending an elongated tool, such as an extended paper clip for example, through opening may be done to actuate the installation button. With such a design, a homeowner would be unlikely to actuate installation button, and may not even know it exists.

Upon receiving a transmission from a sensor including information indicating the presence of the sense condition and information indicating that a test was conducted, e.g., the testing actuator is actuated when the predetermined condition is absent, the control panel does not communicate with the remote monitoring station. As such, a homeowner's test of the sensor by pressing a test button, for example, does not cause a false alarm to be reported to the remote monitoring station. Alternatively, upon receiving a transmission from a sensor including information indicating the presence of the sense condition but without information indicating that a test of the sensor was conducted (whether the transmission was caused by the presence of the sense condition or by the testing actuator being actuated with the predetermined condition present), the control panel communicates to the remote monitoring station information that the sense condition was sensed. The control panel may also provide information identifying the sensor that sensed the sense condition. As such, the predetermined condition is used by an installer, for example, to easily and efficiently cause a communication from the control panel to the remote monitoring station for purposes of fraud prevention measures.

In another implementation, instead of, or in addition to, using the predetermined condition as described previously, the sensor may be provided with an additional, second testing actuator. As with the previously discussed embodiment, in response to the first testing actuator being actuated, the sensor generates a transmission including information indicating the presence of the sense condition and information indicating that a test of the sensor was conducted. In response to actuation of the second testing actuator, however, the sensor generates a transmission including information indicating the presence of the sense condition but not information indicating that a test of the sensor has been conducted.

In this dual testing actuator implementation, the first testing actuator may be a test button provided on an external housing of the sensor and easily accessible by a homeowner, as is typical with smoke detectors, for example. The second testing actuator, however, is preferably not easily accessible to reduce the possibility of accidental actuation by the homeowner and/or the installer. In one implementation, the second testing actuator is inside the sensor's housing, and the housing has a small hole through which a triggering tool, e.g., an extended paper clip, may be extended to actuate the testing actuator within.

The control panel, upon receiving a transmission from a sensor including information indicating the presence of the sense condition and information indicating that a test was conducted, e.g., when the first of the two testing actuators has been actuated, the control panel does not communicate with the remote monitoring station. Upon receiving a transmission from a sensor including information indicating the presence of the sense condition but without information indicating that a test of the sensor was conducted (whether the transmission was caused by the presence of the sense condition or by the second testing actuator being actuated), the control panel communicates to the remote monitoring station information that the sense condition was sensed, and also may provide information identifying the sensor that sensed the sense condition.

Predictive diagnostics system can access database to retrieve the monitored variables and the equipment status information.

In some embodiments, predictive diagnostics system is a component of BMS controller. For example, predictive diagnostics system can be implemented as part of a building automation system. In other embodiments, predictive diagnostics system can be a component of a remote computing system or cloud-based computing system configured to receive and process data from one or more building management systems. For example, predictive diagnostics system can be implemented as part of a building efficiency platform. In other embodiments, predictive diagnostics system can be a component of a subsystem level controller (e.g., a HVAC controller, etc.), a subplant controller, a device controller (e.g., AHU controller, a chiller controller, etc.), a field controller, a computer workstation, a client device, and/or any other sy stem and/or device that receives and processes monitored variables from connected equipment.

### V. Predictive Diagnostics

Predictive diagnostics system may use the monitored variables to identify a current operating state of connected equipment. The current operating state can be examined by predictive diagnostics system to expose when connected equipment begins to degrade in performance and/or to predict when faults will occur. In some embodiments, predictive diagnostics system determines whether the current operating state is a normal operating state or a faulty operating state. Predictive diagnostics system may report the current operating state and/or the predicted faults to client devices, service technicians, building, and/or any other system and/or device. Communications between predictive diagnostics system and other systems and/or devices can be direct and/or via an intermediate communications network, such as network. If the current operating state is identified as a faulty state or moving toward a faulty state, predictive diagnostics system may generate an alert or notification for service technicians to repair the fault or potential fault before it becomes more severe. In some embodiments, predictive diagnostics system uses the current operating state to determine an appropriate control action for connected equipment.

In some embodiments, predictive diagnostics system uses principal component analysis (PCA) models to identify the current operating state. PCA is a multivariate statistical technique that takes into account correlations between two or more monitored variables. Predictive diagnostics system may use the monitored variables to create a plurality of PCA models. Each of the PCA models may characterize the behavior of the monitored system, device, or process in a particular operating state. Predictive diagnostics system may store the PCA models in a library of operating states (e.g., in memory or a database). Predictive diagnostics system may use the library of operating states to determine whether new samples of the monitored variables correspond to any of the previously-stored operating states.

In some embodiments, predictive diagnostics system includes a data analytics and visualization platform. Predictive diagnostics system can analyze the monitored variables to predict when a fault will occur in the connected equipment. Predictive diagnostics system can predict the type of fault and a time at which the fault will occur. For example, predictive diagnostics system can predict when connected equipment will next report a safety fault code that triggers a device shut down. Advantageously, the faults predicted by predictive diagnostics system can be used to determine that connected equipment is in need of preventative maintenance to avoid an unexpected shut down due to the safety fault code. Predictive diagnostics system can provide the predicted faults to service technicians, client devices, building, or other systems or devices.

A system and method of operating a monitoring and response system for an actor in a daily living environment that relies upon learned models of behavior for adapting system operation. The learned model of behavior preferably includes sequential patterns organized pursuant to assigned partition values that in turn are generated based upon an evaluation of accumulated data. Based upon reference to the learned model of behavior the system can generate more appropriate response plans based upon expected or unexpected activities more readily recognize intended activities recognize abandoned tasks formulate probabilities of method choice build probabilities of action success anticipate and respond to actor movement within the environment optimize response plan effectiveness and share learned models across two or more separate system installations. A fault parameter of an energy consumption model is modulated. The energy consumption model is used to estimate an amount of energy consumption at various values of the fault parameter. A first set of variables is generated including differences between a target value of the fault parameter and the various values of the fault parameter. A second set of variables is generated including differences between an estimated amount of energy consumption with the fault parameter at the target value and the estimated amounts of energy consumption with the fault parameter at the various values. The first set of variables and second set of variables are used to develop a regression model for the fault parameter. The regression model estimates a change in energy consumption based on a change in the fault parameter. Regression models are developed for multiple fault parameters and used to prioritize faults.

In some embodiments, predictive diagnostics system provides a web interface which can be accessed by service technicians, client devices, and other systems or devices. The web interface can be used to access the raw data in reporting database, view the results of the predictive diagnostics, identify which equipment is in need of preventative maintenance, and otherwise interact with predictive diagnostics system. Service technicians can access the web interface to view a list of equipment for which faults are predicted by predictive diagnostics system. Service technicians can use the predicted faults to proactively repair connected equipment before a fault and/or an unexpected shut down occurs. These and other features of predictive diagnostics system are described in greater detail below.

A chiller is an example of a type of connected equipment which can be connected to report monitored variables and status information to predictive diagnostics system. It may include or be connected to a refrigeration circuit having a condenser, an expansion valve, an evaporator, a compressor, and a control panel. In some embodiments, chiller includes sensors that measure a set of monitored variables at various locations along the refrigeration circuit. Predictive diagnostics system can use these or other variables to detect the current operating state of chiller, detect faults, predict potential/future faults, and/or determine diagnoses. Predictive diagnostics system may additionally use external parameters such as weather conditions and geographical location where the chiller is operating.

Chiller can be configured to operate in multiple different operating states. For example, chiller can be operated in a low load state, a medium load state, a high load state, and/or various states therebetween. The operating states may represent the normal operating states or conditions of chiller. Faults in chiller may cause the operation of chiller to deviate from the normal operating states. For example, various types of faults may occur in each of the normal operating states. These faults may correspond to leaks, mechanical component failures, electrical component failures, etc.

Predictive diagnostics system may build principal component analysis (PCA) models of the operating states by collecting samples of the monitored variables. For example, predictive diagnostics system may collect 1000 samples of the monitored variables at a rate of one sample per second. The samples of monitored variables can be passed to a data scaler, PCA modeler, and/or other components of predictive diagnostics system and used to construct PCA models for each of the operating states. After the state models are built, new samples of the monitored variables can be processed by predictive diagnostics system to determine the current operating state of chiller. Predictive diagnostics system can determine how close the current operating state is to each of the operating states represented by the PCA models. Predictive diagnostics system can use the proximity of the current operating to states to each of the modeled operating states to predict when a fault will occur.

Faulty operations of HVAC chiller systems can lead to discomfort for the users, energy wastage, system unreliability, and shorter equipment life. It may therefore be advantageous to diagnose faults early to prevent deterioration of system behavior, energy losses, and/or increased costs. To increase the sustainability of BMS, more robust, scalable, and smart techniques are needed. Traditionally, rule-based diagnostic systems have been implemented to diagnose faults and/or failures. However, conventional, hardcoded, rule-based approaches tend to work only if all the situations under which decisions can be made are known and defined. By way of example, when a chiller gets operationalized, the chiller may have a finite number of rules (e.g., 5, 10, 15, etc.) to handle known faults that may occur with the chiller. Over time, as more faults arise in this system, more rules get manually entered into the system. As time goes by, adding new rules can get awkward and cumbersome, especially when data changes faster than one can keep up with the rules.

According to an exemplary embodiment, predictive diagnostics system is configured to learn from past data and create an algorithmic model which can autonomously (i) update itself and make predictions according to the changing time frame and geographical conditions, (ii) recognize patterns exhibited by faults, and/or (iii) automatically find the most likely diagnostics by learning from the patterns exhibited by the faults. Predictive diagnostic system (e.g., the integration of autonomous learning systems (ALS) within chiller operations, etc.) may make it is possible to minimize dependency on expert human operators for carrying out cumbersome tasks of predefining rule bases for each machine parameter separately and/or enable vendors and building owners to take prior measures for preventative maintenance of chillers.

As a brief overview, predicative diagnostics system may start with gathering data and/or parameters from one or more chillers. Predicative diagnostics system may then create a hypothetical separating hyperplane autonomously based on the cumulative probability distribution of the chiller parameters. This may help in learning the faulty situations for chiller operation. After that, predicative diagnostics system may recognize patterns exhibited by discovered faults. An overall model developed by predicative diagnostics system can be utilized to find unprecedented fault patterns. Predicative diagnostics system may further be configured to predict whether real time operating conditions are “trending” to be faulty or are normal. For example, predictive diagnostics system can determine that a chiller is trending toward a faulty state if the data gathered from the chiller are approaching a set of values previously classified as faulty. If the predicted conditions are becoming faulty, predicative diagnostics system may implement an effective diagnostic scheme which may help in the rectification of the fault before it actually arises. Predicative diagnostics system may also perform such analysis based on external parameters such as weather conditions and/or the geographical location where a chiller is operating.

Predictive diagnostics system may include a communications interface and a processing circuit. Communications interface may facilitate communications between predictive diagnostics system and various external systems or devices. For example, predictive diagnostics system may receive the monitored variables from connected equipment and provide control signals to connected equipment via communications interface. Communications interface may also be used to communicate with remote systems and applications, client devices, and/or any other external system or device. For example, predictive diagnostics system may provide fault detections, diagnoses, and fault predictions to remote systems and applications, client devices, service technicians, or any other external system or device via communications interface.

Communications interface can include any number and/or type of wired or wireless communications interfaces (e.g., jacks, antennas, transmitters, receivers, transceivers, wire terminals, etc.). For example, communications interface can include an Ethernet card and port for sending and receiving data via an Ethernet-based communications link or network. As another example, communications interface can include a WiFi transceiver, an NFC transceiver, a cellular transceiver, a mobile phone transceiver, or the like for communicating via a wireless communications network.

Process includes identifying a plurality of building objects (e.g., including building devices, software defined building objects, or other inputs to the BMS that affect the building environment). Process also includes identifying the causal relationships between the identified building objects. Steps may include testing building inputs and outputs for the causal relationships using an automated process. The identifying steps may also or alternatively include using an automated process to analyze characteristics of BMS devices and signals to create software defined building objects and their causal relationships to each other. In yet other exemplary embodiments, the identifying steps include causing a graphical user interface to be displayed that allows a user to input the building objects and the causal relationships between the objects.

Process is further shown to include relating the identified objects by the causal relationships. Relating the identified objects by causal relationships may be completed by an automated process (e.g., based on testing, based on signal or name analysis at a commissioning phase, etc.) or by user configuration (e.g., of tables, of graphs via a graphical user interface, etc.). In an exemplary embodiment, a graphical user interface may be provided for allowing a user to draw directional links between building objects. Once a link is drawn, a computerized process may cause a dialog box to be shown on the GUI for allowing a user to describe the created causal relationship.

Process is yet further shown to include describing the causal relationships (step 308). The description may be found and stored using any of the previously mentioned processes (e.g., automated via testing, manually input via a keyboard or other user input device, etc.). In one set of exemplary embodiments, the user is able to select (e.g., via a drop down box, via a toolbox, etc.) from a pre-defined list of possible causal relationship descriptions or to insert (e.g., type) a custom causal relationship description at a graphical user interface.

Process is yet further shown to include storing the causal relationships and descriptions in a memory device of the BMS. The causal relationships may be stored using any of the above-described information structures (e.g., stored in tables, stored as lists linked to object properties, stored as a systems of linked lists, etc.).

While the causal relationship models of the present disclosure may not be stored or represented as static hierarchical models (e.g., a tag-based hierarchical model description), systems and methods of the present disclosure are configured to allow the creation of multiple hierarchical views of the causal relationship models. Each “view” may be defined as a hierarchical model (e.g., tree model) in memory to which one or more causal relationship models can be applied or projected.

The AHU may control a VAV box, which in turn ventilates a conference room. Any number or type of hierarchical models may be created and used to describe complex causal relationship models. In conventional systems, a building may only be described using a single static hierarchical tree (e.g., top down, one head node, showing control connections). The present disclosure allows the user or the system to establish many different new information structures by applying desired hierarchical models (e.g., bottom-up, top-down, selecting a new head node, etc.) to the stored causal relationship models. The hierarchical models may be used for reporting, displaying information to a user, for communication to another system or device (e.g., PDA, client interface, an electronic display, etc.), or for further searching or processing by the BMS or the computing system.

Each level of the resultant hierarchical trees may be optionally constrained or not constrained to a certain number of entities (this may be set via by updating one or more variables stored in memory, providing input to a user interface, by coding, or otherwise). In the first hierarchical result shown above, for example, only a single primary VAV box may be specified to be shown for each conference room, even though there may be more VAV boxes associated with the conference room. In an un-constrained hierarchical result, the hierarchical list for each conference room would include all related building objects.

The BMS controller may be configured to use causal relationship models that may be updated during run time (e.g., by one or more control processes of the system, by user manipulation of a graphical user interface, etc.). Any modification of the causal relationship structure, in such embodiments, may be immediately reflected in applications of hierarchical models. In other words, as the building changes, the BMS controller (with or without the aid of a user) may be configured to update the causal relationship models which in turn will be reflected in the results of applying a hierarchical models to the causal relationships.

A process for using a hierarchical model of building objects is shown, according to an exemplary embodiment. Process includes defining a hierarchical model of building objects (e.g., such as those shown above or otherwise formatted). Process also includes traversing the stored causal relationships to generate a hierarchical result according to the defined hierarchical model. Alternatively, the hierarchical result may be generated by querying the stored causal relationship. For example, a tree storing causal relationships may be traversed to generate the hierarchical results, whereas a table storing causal relationships may be queried.

The hierarchical result may be used to create a graphical representation of the result for display (e.g., at a client, on a report, on a local electronic display system, etc.). A graphical user interface including a tool for allowing a user to define new hierarchical models or to revise a previously defined hierarchical model may further be provided to a user via a display system or client. In step of process, at least a portion of the hierarchical result is traversed to generate a report. The hierarchical result or a group of results may be processed by one or more processing modules, reporting modules, or user interface modules for further analysis of the BMS or for any other purpose (e.g., to further format or transform the results).

A flow diagram of a process to provide a graphical user interface for allowing users to view or interact with a causal relationship model is shown, according to an exemplary embodiment. Process includes providing at least one tool (e.g., to a graphical user interface, as a text-based interface, etc.) for allowing a user to view or to change a directed graph of the causal relationships and building objects displayed on the graphical user interface. The tool for changing the directed graph may be the same as the tool for identifying the objects and the relationships elsewhere in the system or process, or may be a different tool for conducting revisions after an initial modeling. Process also includes displaying a graphical user interface that includes a tool for allowing a user to define a new hierarchical model or to revise the hierarchical model. Process further includes displaying a graphical user interface that includes a directed graph representing the causal relationships. Process also includes providing at least one tool for allowing a user to change the directed graph displayed on the graphical user interface. Finally, process includes updating the causal relationships stored in memory based on the changes made by the user to the directed graph.

A query engine can use the causal relationship and hierarchical projection and methods described above to allow inspection (e.g., querying, searching, etc.) within the graph through structured searches. According to an exemplary embodiment, query statement may be provided to query engine via user interface module, client services, or application services. In this way, a module of the computer system, a client process, or a user via a graphical user interface or another tool (e.g., text-based query engine) may submit a structured query statement to query engine. In some embodiments, query engine resides remotely from interface module and from services, and communicates with them via middleware over a network. Query engine may be configured to receive and parse the structured query statement using statement parser. The parsing may seek out key words (e.g., causal relationships, object types, object names, class names, property names, property values, etc.) in query statement. Key words that are found may be used by projection generator to construct (e.g., using a computerized process) a hierarchical model for use in conducting a search for relevant objects or for filtering the search via one or more filtering steps

Yet another possible application of the learned models of behavior is developing/sharing of learned models across two or more separate system installations. It is recognized that a particular learned model will likely be specific to a particular actor/environment. However, a learned model of behavior developed for a first system could be used to improve the default behavior of a second system installation for a different actor. For example, the “normal” behavior of a “normal” actor/environment can be modeled, and then used as a baseline to learn the behavior of a second actor/environment. The learning process associated with the second actor/environment will then be much faster. In short, shared learning across two or more systems enables global lessons to be learned (server side learning). Even further, a meta-model of behavior can be created by merging at least two learned models from the same or different system installations, with the meta-model being used as part of the operations of one or more of the systems (or an entirely separate system) as a baseline or to assess system coverage (e.g., whether all sensors are being understood; how much of understanding any one system has of its corresponding actor's behavior; etc.).

Many of the examples of learning given above can proceed without any intervention from an authority or oracle, a style of learning known as “unsupervised learning”. The path model provided above is an example whereby paths can be learned passively by the system via observation of room occupancy over time. Other sorts of learning that require feedback from the actor, the actor's caregiver, and/or other system modules (“supervised learning”) are also optionally employed in accordance with the present invention. Feedback may take the form of explicit preferences (e.g., the actor rank orders some available options). Alternatively, the feedback information can be derived from specific statements provided by the actor (e.g., “I prefer a phone to a pager,” or “Don't remind me to use the bathroom when I have guests”.). The feedback may also involve a teacher labeling training cases for the student module/agent. An example of this is a teacher telling a learning acoustic monitoring module/agent that “the sounds you heard between 8:40 and 8:55 was the actor preparing breakfast in the kitchen”. Alternatively, feedback from a person other than the actor can be response(s) to questions posed by the system. Finally, feedback may be non-specific reinforcement indicating relative success or failure to meet a system goal. Reinforcement learning could be particularly applied to the problem of learning the effectiveness of plans or actions. Learned actor preferences can be weighed against measured effectiveness. Using a plan known to be more effective may in some cases trump the desire to conform to the actor's preferences.

Because adaptive systems changes themselves after installation, the present invention preferably includes mechanisms to ensure safety and reliability of the installed system. Learned knowledge is checked against built-in knowledge to prevent the system from acquiring dangerous or “superstitious” behaviors. The adaptive components of the system allow the configure, and optionally the actor, to disable learning, check point their lessons (freeze), or re-set their learned state to a previous check point, including factory defaults.

One preferred learned model behavior building technique in accordance with the present invention is sequential pattern learning adapted to learn what sensor firings (or other stored information, such as the feedback information described above) correspond to what activities, in what order, and at what time. The technique of sequential pattern mining provides a basis for recognizing these activities and their order. A “sequential pattern” is defined as a list of sensor firings ordered in time. Sequential pattern mining addresses the problem of finding frequent sequential patterns. In a preferred embodiment, the sequential pattern learning associated with the machine learning module extends currently available sequential pattern techniques to incorporate reasoning about the time of the activities.

To better understand the preferred sequential pattern learning technique associated with the machine learning module of the present invention, the foregoing discussion incorporates hypothetical installation details for the system, and in particular, types of sensors and environment attributes. These hypotheticals are in no way limiting as the system and method of the present invention can be applied in a wide variety of settings.

One particular hypothetical system installation includes a motion sensor positioned in a bathroom, a motion sensor positioned in a bedroom, a motion sensor positioned in the kitchen, and a motion sensor positioned in a living room. Patterns may be found based on gathered information. From an implementation standpoint, it is not enough to simply apply the sequential pattern algorithm to sensor data and hope to discover sequential patterns that will meaningfully model the actor's behavior and/or behavior of the actor's environment. This is because an accurate explanation of what each discovered pattern represents cannot be provided. For example, relative to the above hypothetical data, firing of the bedroom motion sensor may represent several types of activities, such as the actor waking up in the morning, the actor entering the bedroom in the evening to go to sleep, etc. One preferred technique of attaching a meaning to a pattern is to determine the time periods during which each of the monitored sensors are firing. For example, and again relative to the above hypothetical, the examples of discovered sequential patterns can now be designated as: after a bedroom motion sensor firing between 6:45 a.m. and 7:45 a.m., the bathroom motion sensor fires between 7:00 a.m. and 8:00 a.m. 75% of the observed time; and in 60% of the observed days, the pattern kitchen motion sensor fires between 6:00 p.m. and 6:30 p.m. followed by the living room motion sensor firing between 6:20 p.m. and 7:00 p.m. followed by the bedroom motion sensor firing between 9:00 p.m. and 10:00 p.m.

In light of the above, identification of appropriate time periods for each sensor makes it easier to attach a meaning to the pattern learned through unsupervised learning. In the above examples, the first pattern might represent the actor's waking-up routine, while the second pattern might represent the actor's after work/evening routine.

In order to properly identify intervals of occurrence of each event in a sequential pattern as highlighted by the above examples, the machine learning module preferably identifies appropriate time periods or intervals for each sensor firing. In this regard, one approach is to generate the intervals during the sequential patterns' discovery phase. However, the overhead is intractable, since all possible intervals must be considered. Alternatively, and in accordance with one preferred embodiment of the present invention, the time intervals are predetermined and enumerated before sequential pattern learning occurs. It is recognized that this approach has the potential drawback that the quality of the discovered patterns can be affected by the way the system and/or the module defines the intervals. However, to minimize this possibility, the preferred machine learning module does not predefine “fixed-width” time intervals, but instead determines time intervals based upon the distribution of sensor firings during the day.

### VI. Machine Learning

The preferred time interval determination defines time intervals as intervals between successive local minimas of the probability density function. An important concept underlying this approach is that an actor usually performs each daily activity during a certain time period. For example, the actor may typically wake-up between 8:00 a.m. and 9:00 a.m. A sequence of sensor firings with attached or correlated timings (or “timestamps”) of between 8:00 a.m. and 9:00 a.m. would thus represent a “waking-up” activity.

Because some sensors will fire more frequently than others within a particular installation and will likely measure different kinds of activities, the preferred machine-learning module determines time intervals by determining probability density functions for each sensor separately. By estimating a probability density function for each individual sensor, the frequency of sensor activity can be accounted for when identifying event occurrence intervals.

The key component associated with the system of the present invention resides in the machine learning module as described below. As such, the sensors, the actuators, as well as other modules (e.g., the situation assessment module and the response planning module) can assume a wide variety of forms. Preferably, the sensors are networked by the controller. The sensors can be non-intrusive or intrusive, active or passive, wired or wireless, physiological or physical. In short, the sensors can include any type of sensor that provides information relating to the activities of the actor or other information relating to the actor's environment. For example, the sensors can include motion detectors, pressure pads, door latch sensors, panic buttons, toilet-flush sensors, microphones, cameras, fall-sensors, door sensors, heart rate monitor sensors, blood pressure monitor sensors, glucose monitor sensors, moisture sensors, light level sensors, smoke/fire detectors, thermal sensors, water sensors, seismic sensors, etc. In addition, one or more of the sensors can be a sensor or actuator associated with a device or appliance used by the actor, such as a stove, oven, television, telephone, security pad, medication dispenser, thermostat, etc., with the sensor or actuator providing data indicating that the device or appliance is being operated by the actor (or someone else).

Similarly, the actuators or effectors can also assume a wide variety of forms. In general terms, the actuators or effectors are configured to control operation of a device in the actor's environment and/or to interact with the actor. Examples of applicable actuators or effectors include computers, displays, telephones, pagers, speaker systems, lighting systems, fire sprinkler, door lock devices, pan/tilt/zoom controls on a camera, etc. The actuators or effectors can be placed directly within the actor's environment, and/or can be remote from the actor, providing information to other persons concerned with the actor's daily activities (e.g., caregiver, family member(s), etc.). For example, the actuator can be a speaker system positioned in the actor's kitchen that audibly provides information to the actor. Alternatively, and/or in addition, the actuator can be a computer located at the office of a caregiver for the actor that reports desired information (e.g., a need to refill a particular medication prescription).

The controller is preferably a microprocessor-based device capable of storing and operating the various modules. With respect to the other modules, each can be provided as individual agents or software modules designed around fulfilling the designated function. Alternatively, one or more of the modules can instead be a grouping or inter-working of several individual modules or components that, when operated by the controller, serve to accomplish the designated function. Even further, separate modules can be provided for individual subject matters that internally include the ability to perform one or more of the functions associated with the monitoring module, the situation assessment module, the response planning module, as well as other functions desired for the monitoring and response system. Regardless of exact configuration, however, the modules serve to monitor information provided by the sensors, assess the current situation of the actor and/or the actor's environment, generate appropriate interactive plans responsive to the determined situation, and effectuate those plans (relative to the actor and/or anything in the environment) via the actuators. Additional features may include an ability to determine intended actions of the actor, evaluate system operations based upon unobserved actions of the actor, stored data logs, etc. Regardless, the system preferably makes use of information generated by the machine learning module in the operation of one or more, preferably all, of the various other modules.

With the above in mind, the machine learning module preferably provides a means for on-going adaptation and improvement of system responsiveness relative to the needs of the actor. The machine learning module preferably entails a learned behavior model built over time for the actor and/or the actor's environment (including persons other than the actor). In general terms, the learned model is built by accumulating passive (or sensor-supplied) data and/or active (actor and/or caregiver generated) data in an appropriate database. The resulting learned models are then available to the controller (or modules therein) for enabling the system to automatically configure itself and to adapt to changing conditions, minimizing the time and labor involved in set-up and maintenance. Further, the learned models of behavior can be employed to assist in selecting a most appropriate response plan, including the quality and presentation of the interaction. Even further, the learned models of behavior can be utilized by other monitoring and response systems for improved default installation parameters and designations. In short, the learned models of behavior can be used to improve general system performance.

The machine learning module is preferably configured to generate learned models of behavior for a number of different events, activities, or functions (of the actor, the environment, or the system). The goal of the machine learning module is to model the actor's and/or the actor's environment behavior with enough accuracy to recognize situations and respond to situations. The data used by the machine learning module in generating these learned models of behavior is provided by the sensors (unsupervised learning) and/or feedback from the actor or others (supervised learning). To this end, and as used throughout the specification, reference is made to “firing” of a sensor. This is intended to mean that a particular passive sensor has been “activated” or otherwise sensed an action (e.g., a motion sensor “fires” when something moves through, for example, a light beam; a glass break sensor “fires” when the glass to which the sensor is associated with breaks, etc.), or that an active “sensor” has received information indicative of a particular action or activity.

With this in mind, examples of learned models of the actor include patterns of the actor over a week (such as waking/sleeping times, toilet use), activity schedules (bathing, cooking, recreation, etc.), paths normally followed by the actor when moving from room to room, preferences for and efficacy of interaction models, etc. Learned models of the environment include, for example, patterns such as expected background noise, patterns of visitors to the home, appliance power use signatures, efficacy of interaction models with other actors, etc. Learned models relating to performance of the system include, for example, sensor reliability and actuator response time (e.g., how long it takes to clear smoke from a particular room). Similarly, the effectiveness of learned models can be learned, as well as a breadth of system coverage (e.g., how much learning is needed a priori or based on learned models from other system installations). Further, the learned models can indicate system sensitivity to changes (e.g., how quickly the system must adapt to changes in an elderly actor) and robustness in the presence of a typical events.

A variety of techniques can be employed by the machine learning module to build the learned models of behavior (e.g., actor's behavior, environment's behavior, or any other “tracked” persons or things in the environment). In general terms, the learned models of behavior can be built using calibrated, simple parametric models; trending, averages, and other statistical measures; sequences of or correlations between sensor/actuator firings/usage; sequences or structure of inferred activity models; timings associated with the above and/or probability transitions associated with the above.

Regardless of how the machine learning module generates learned models of behavior, the so-generated information can be utilized in a number of fashions. For example, (1a) the system can incorporate several machine learning modules, with each module being adapted to generate data for one or more other modules or agents (i.e., the situation assessment module, the response planning module, etc.) that is otherwise adapted to utilize the generated information. For example, an alarm module can be provided as part of the system that is adapted to raise an alarm for unexpected activities (e.g., the back door being opened at 3:00 a.m.). In a preferred embodiment, this alarm module functions by understanding when an activity is “normal” based upon the learned models of behavior generated by the machine-learning module. Similarly, (2) the learned models of behavior information can be utilized to raise an alarm for expected activity that does not otherwise happen (e.g., the actor normally gets out of bed by 8:00 a.m. as determined by the machine learning module, on a particular day when the actor does not get out of bed by that time, an alarm would be raised). Further, (3) the machine learning module can be utilized in generating probabilities for the likelihood that an activity “will be engaged in”, with the information being used by an intent recognition module or agent that would bias its recognition of an activity accordingly (e.g., if the machine learning module determines or indicates that it is extremely likely that a cooking activity happens at 5:00 p.m., then the intent recognition module is more likely to recognize a cooking activity at that time even if the sensors are providing information that does not fully substantiate such a conclusion).

Also, the machine learning module can be utilized in building probabilities that tasks will be abandoned (e.g., the actor is two-thirds finished making breakfast, the phone rings, and the actor then forgets to finish breakfast; the machine learning module builds a model of the normal “breakfast making” steps from which a determination can be made that because one or more remaining, identified steps have not been completed, the breakfast making activity has been abandoned). Additionally, the machine learning module can build probabilities for method choice (e.g., the actor can make breakfast either by using the microwave or the stove or the toaster; what are the probabilities of each of these occurring). Further, the machine learning module can build probabilities of action success (e.g., that the actor will reach a desired person by telephone at a certain time of the day).

Another application is in determining and applying learned models of paths the actor normally follows at certain times in the day, and then be useful for anticipating the actor's path and effectuate turning on relevant lights, opening doors, etc. Similarly, the learned models can determine normal timings between certain, regular activities. For example, the learned models can postulate that the actor normally eats lunch three hours after breakfast. This timing information can then be utilized in anticipating further events (e.g., in furtherance of the previous example, if it is determined that the actor ate breakfast at a time of day later than normal, the timing information can be used to anticipate that lunch will also be consumed at a time later than normal).

Yet another possible application of the learned models of behavior is understanding the effectiveness of a particular plan generated by the response planning module. For example, the machine learning module can be utilized to determine the most effective recipient (e.g., the actor or other human) of a particular message; the most effective device on which to deliver a message; the most effective modality for a message; the most effective volume, repetition, and/or duration within a modality; and the actor's preferences regarding modality, intensity, etc. In this regard, the mechanism for learning might be very simple at first but could become increasingly sophisticated by using contextual conditions for lessons (e.g., “the audio messages are ineffective when the actor is not in the same room as the speaker”).

It will be understood that some embodiments is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A system for detecting or addressing a fire or fire related event in a facility, the system being configured for use with multiple fire related sensors and equipment, the system also being configured for use with mobile devices of system users, the system comprising:
a controller configured to continuously interrogate status of the fire related sensors and equipment, identify a change in the status, and classify the status change according to operation state and probability of the fire related event, the controller also being configured to access data of the mobile devices to determine whether the mobile devices are disposed within the facility;
a network that is configured to enable communications between the controller, the fire related sensors and equipment, and the mobile devices; and
a storage medium that stores data received from the controller and from which the controller is configured to analyze patterns in the fire related sensors and equipment that enable prediction of the fire related event and measures for enhancing outcomes.
